(19) United States
(12) Patent Application Publication
(10) Pub. No.: US 2015/0128130 A1
(43) Pub. Date: May 7, 2015

(54) METHOD AND SYSTEM FOR PROVIDING AND DYNAMICALLY DEPLOYING HARDENED TASK SPECIFIC VIRTUAL HOSTS

(71) Applicant: Intuit Inc., Mountain View, CA (US)

(72) Inventors: Brett Weaver, San Diego, CA (US); Capen Brinkley, San Diego, CA (US); Jeffrey M. Wolfe, Parrish, FL (US); Ankur Jain, Redwood City, CA (US); M. Shannon Lietz, San Marcos, CA (US); Luis Felipe Cabrera, Bellevue, WA (US)

(73) Assignee: Intuit Inc., Mountain View, CA (US)

(21) Appl. No.: 14/070,124

(22) Filed: Nov. 1, 2013

(51) Int. Cl. G06F 9/455

(52) U.S. Cl. CPC G06F 9/455
USPC 718/1

(57) ABSTRACT

Virtual host creation data used to instantiate a hardened task specific virtual host in a first computing environment is generated including hardening logic for providing enhanced security and trust for the hardened task specific virtual host and internal task specific logic for directing and/or allowing the hardened task specific virtual host to perform a specific function assigned to the hardened task specific virtual host. When task data is received indicating a task to be performed in the first computing environment requires the performance of the specific function assigned to the hardened task specific virtual host, the hardened task specific virtual host is automatically instantiated and/or deployed in the first computing environment.

### BACKGROUND

As various forms of distributed computing, such as cloud computing, have come to dominate the computing landscape, security has become a bottleneck issue that currently prevents the complete migration of various capabilities and systems associated with sensitive data, such as financial data, to cloud-based computing environments, and/or other distributive computing models. This is because many owners and operators of data centers that provide access to data and other resources are extremely hesitant to allow their data and resources to be accessed, processed, and/or otherwise used, by virtual assets, such as virtual machine and server instances, in the cloud.

One long standing problem associated with providing security in a cloud computing environment is the current inability to efficiently and effectively separate duties/tasks and functions so that individual tasks can be performed in private and isolated sub-environments to protect data and other resources from various forms of attack. One reason efficient and effective task separation is currently not available is that various methods for creating isolated environments, such as currently available bastion hosts and other administrative capabilities, are either statically created, and for all practical purposes are single use and inflexible in application, or are of a general/public nature and therefore fail to provide the privacy, level of isolation, and separation of duties desired.

As a specific illustrative example, currently available bastion hosts are generally created as relatively static systems that, once deployed, operate within rather narrow initial operational parameters and perform the limited tasks they were designed to perform indefinitely, without the ability to either modify the function of the bastion hosts in any significant way, or redeploy and/or repurpose the bastion hosts. Consequently, if currently available bastion hosts are used as the primary mechanism to create what are often temporarily needed isolated sub-environments, and/or perform separated duties, then any number of duties more than a relatively trivial number of duties to be separated and performed in isolated environments results in an unacceptable amount of resources being devoted to multiple static bastion hosts.

As another specific illustrative example, in many cases, such as forensic analysis, data must be collected from multiple virtual assets, such as virtual machine and server instances, or data stores, in a cloud computing environment, and then this data must be correlated and processed. Currently, the administration of these data collection processes is largely done using centrally implemented and generalized administrator functions and the data collection is performed in a way that is relatively transparent to other assets, instances, and parties in the cloud. In terms of security, this is a less than ideal situation.

What is needed is a method and system that leverages currently available cloud computing infrastructure to provide virtual assets that can be created or destroyed as needed to perform specific functions/tasks and that include enhanced security, or hardening, logic so that the virtual assets can be designated trusted agents in one or more computing environments.

### SUMMARY

In accordance with one embodiment, a method and system for providing and dynamically deploying hardened task specific virtual hosts includes generating virtual host creation data through a virtual asset creation system. In one embodiment, the virtual host creation data is used to instantiate a hardened task specific virtual host in a first computing environment. In one embodiment, the virtual host creation data includes hardening logic for providing enhanced security and trust for the hardened task specific virtual host and internal task specific logic for directing and/or allowing the hardened task specific virtual host to perform a specific function assigned to the hardened task specific virtual host.

In one embodiment, task data is received indicating a task to be performed in the first computing environment. In one embodiment, the task data is analyzed and a determination is made that the task to be performed in the first computing environment requires the performance of the specific function assigned to the hardened task specific virtual host. In one embodiment and the hardened task specific virtual host is then automatically instantiated and/or deployed in the first computing environment.

In accordance with another embodiment, a method and system for providing and dynamically deploying hardened task specific virtual administrative hosts includes generating one or more types of virtual host creation data through a virtual asset creation system. In one embodiment, each of the one or more types of virtual host creation data is used to instantiate one of one or more types of hardened task specific virtual administrative hosts in a first computing environment. In one embodiment, the virtual host creation data for each type of hardened task specific virtual administrative host includes hardening logic for providing enhanced security and trust for the type of hardened task specific virtual administrative host and internal task specific logic for directing and/or allowing each type of hardened task specific virtual administrative host to perform a different specific administrative function assigned to that type of hardened task specific virtual administrative host.

In one embodiment, when task data indicating an administrative task to be performed in the first computing environment is received, the task data is analyzed to determine if the administrative task to be performed in the first computing environment requires the performance of one or more administrative functions assigned to one or more of the one or more types of hardened task specific virtual administrative hosts. In one embodiment, if it is determined that the administrative task requires the performance of one or more administrative functions assigned to one or more of the one or more types of hardened task specific virtual administrative hosts, the one or more types of hardened task specific virtual administrative hosts assigned the required administrative functions are instantiated and/or deployed in the first computing environment using the virtual host creation data.

In accordance with another embodiment, a method and system for providing and dynamically deploying hardened task specific virtual bastion hosts includes generating one or more types of virtual host creation data through a virtual asset creation system. In one embodiment, each of the one or more types of virtual host creation data is used to instantiate one of one or more types of hardened task specific virtual bastion hosts in a first computing environment. In one embodiment, the virtual host creation data for each type of hardened task specific virtual bastion host includes hardening logic for providing enhanced security and trust for the type of hardened task specific virtual bastion host and internal task specific logic for directing and/or allowing each type of hardened task specific virtual bastion host to perform a different specific function assigned to that type of hardened task specific virtual bastion host.

In one embodiment, when task data indicating a task to be performed in the first computing environment is received, the task data is analyzed to determine if the task to be performed in the first computing environment requires the performance of one or more functions assigned to one or more of the one or more types of hardened task specific virtual bastion hosts. In one embodiment, if it is determined that the task requires the performance of one or more functions assigned to one or more of the one or more types of hardened task specific virtual bastion hosts, the one or more types of hardened task specific virtual bastion hosts assigned the required functions are instantiated and/or deployed in the first computing environment using the virtual host creation data.

In accordance with another embodiment, request data is received from a requesting virtual asset in a first computing environment, the request data requesting access to one more assets. In one embodiment, the requesting virtual asset is then authenticated.

The request data is then analyzed to determine one or more request related functions that need to be performed to provide the access indicated in the request data. In one embodiment, one or more types of virtual host creation data are then generated through a virtual asset creation system. In one embodiment, each of the one or more types of virtual host creation data is used to instantiate one of one or more types of hardened task specific virtual hosts in the first computing environment. In one embodiment, the virtual host creation data for each type of hardened task specific virtual host includes hardening logic for providing enhanced security and trust for the type of hardened task specific virtual host and internal task specific logic for directing and/or allowing each type of hardened task specific virtual host to perform a different request related function of the one or more request related functions that need to be performed to provide the access indicated in the request data.

In one embodiment, the one or more types of hardened task specific virtual hosts assigned a request related function are then instantiated and/or deployed in the first computing environment using the virtual host creation data to help provide the access requested through the request data.

### BRIEF DESCRIPTION OF THE DRAWINGS

FIG. 1 is a functional block diagram showing the interaction of various elements for implementing one embodiment of a process for providing and dynamically deploying hardened task specific virtual hosts;

FIG. 2 is a functional diagram of a hardened task specific virtual host creation template in accordance with one embodiment;

FIG. 3 is a flow chart depicting a process for providing and dynamically deploying hardened task specific virtual hosts in accordance with one embodiment;

FIG. 4 is a functional block diagram showing the interaction of various elements for implementing one embodiment of a process for providing and dynamically deploying hardened task specific virtual administrative hosts;

FIG. 5 is a functional diagram of a hardened task specific virtual administrative host creation template in accordance with one embodiment;

FIG. 6 is a flow chart depicting a process for providing and dynamically deploying hardened task specific virtual administrative hosts in accordance with one embodiment;

FIG. 7 is a functional block diagram showing the interaction of various elements for implementing one embodiment of a process for providing and dynamically deploying hardened task specific virtual bastion hosts;

FIG. 8 is a functional diagram of a hardened task specific virtual bastion host creation template in accordance with one embodiment; and

FIG. 9 is a flow chart depicting a process for providing and dynamically deploying hardened task specific virtual bastion hosts in accordance with one embodiment.

Common reference numerals are used throughout the FIGS. and the detailed description to indicate like elements. One skilled in the art will readily recognize that the above FIGS. are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIGS., which depict one or more exemplary embodiments. Embodiments may be implemented in many different forms and should not be construed as limited to the embodiments set forth herein, shown in the FIGS., and/or described below. Rather, these exemplary embodiments are provided to allow a complete disclosure that conveys the principles of the invention, as set forth in the claims, to those of skill in the art.

In accordance with one embodiment, a method and system for providing and dynamically deploying hardened task specific virtual hosts includes a process for providing and dynamically deploying hardened task specific virtual hosts implemented, at least in part, by one or more computing systems.

As used herein, the term “computing system”, includes, but is not limited to, a server computing system; a workstation; a desktop computing system; a database system or storage cluster; a switching system; a router; any hardware system; any communications systems; any form of proxy system; a gateway system; a firewall system; a load balancing system; or any device, subsystem, or mechanism that includes components that can execute all, or part, of any one of the processes and/or operations as described herein.

In addition, as used herein, the term computing system, can denote, but is not limited to, systems made up of multiple server computing systems; workstations; desktop computing systems; database systems or storage clusters; switching systems; routers; hardware systems; communications systems; proxy systems; gateway systems; firewall systems; load balancing systems; or any devices that can be used to perform the processes and/or operations as described herein.

In various embodiments, the one or more computing systems implementing the process for providing and dynamically deploying hardened task specific virtual hosts are logically or physically located, and/or associated with, two or more computing environments. As used herein, the term “computing environment” includes, but is not limited to, a logical or physical grouping of connected or networked computing systems using the same infrastructure and systems such as, but not limited to, hardware systems, software systems, and networking/communications systems. Typically, computing environments are either known environments, e.g., “trusted” environments, or unknown, e.g., “untrusted” environments. Typically trusted computing environments are those where the components, infrastructure, communication and networking systems, and security systems associated with the computing systems making up the trusted computing environment, are either under the control of, or known to, a party. In contrast, unknown, or untrusted computing environments are environments and systems where the components, infrastructure, communication and networking systems, and security systems implemented and associated with the computing systems making up the untrusted computing environment, are not under the control of, and/or are not known by, a party, and/or are dynamically configured with new elements capable of being added that are unknown to the party.

Examples of trusted computing environments include the components making up data centers associated with, and/or controlled by, a party and/or any computing systems, and/or networks of computing systems, associated with, known by, and/or controlled by, a party. Examples of untrusted computing environments include, but are not limited to, public networks, such as the Internet, various cloud-based computing environments, and various other forms of distributed computing systems.

It is often the case that a party desires to transfer data to, and from, a first computing environment that is an untrusted computing environment, such as, but not limited to, a public cloud, a virtual private cloud, and a trusted computing environment, such as, but not limited to, networks of computing systems in a data center controlled by, and/or associated with, the party. However, in other situations a party may wish to transfer data between two trusted computing environments, and/or two untrusted computing environments.

In one embodiment, two or more computing systems, and/or two or more computing environments, are connected by one or more communications channels, and/or distributed computing system networks, such as, but not limited to: a public cloud; a private cloud; a virtual private cloud (VPN); a subnet; any general network, communications network, or general network/communications network system; a combination of different network types; a public network; a private network; a satellite network; a cable network; or any other network capable of allowing communication between two or more computing systems, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more computing systems, whether available or known at the time of filing or as later developed.

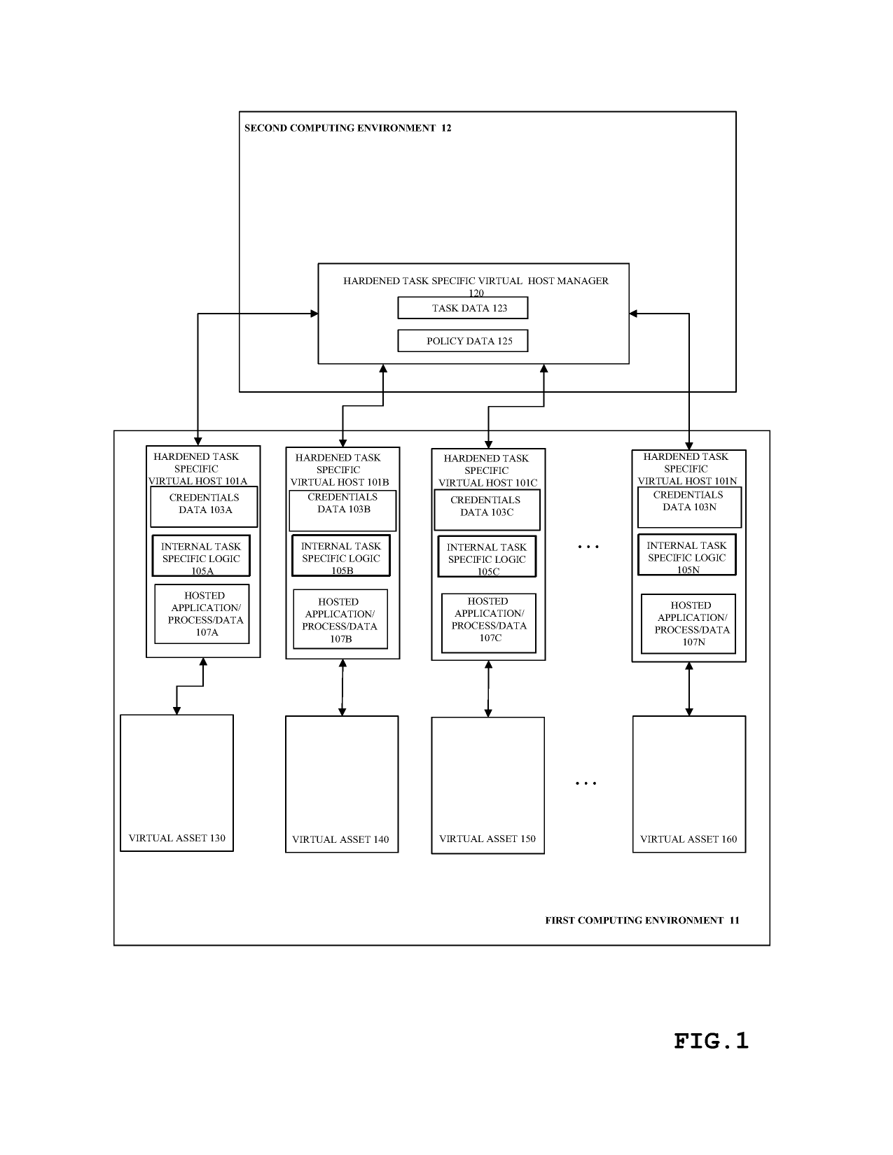

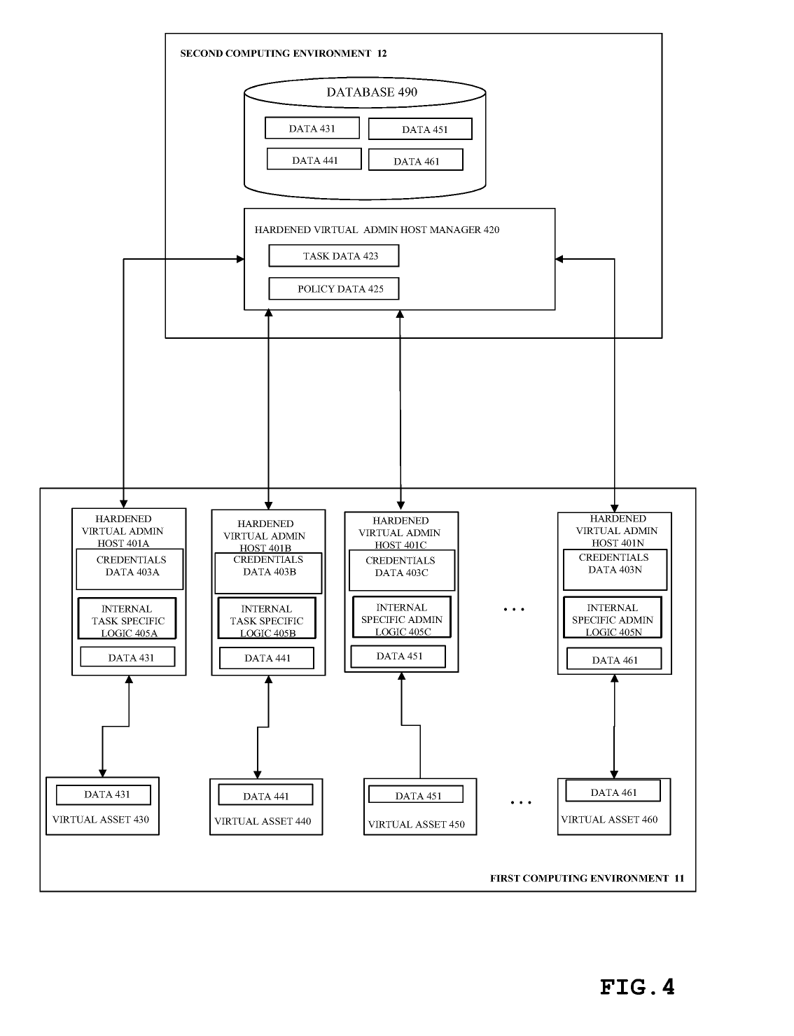

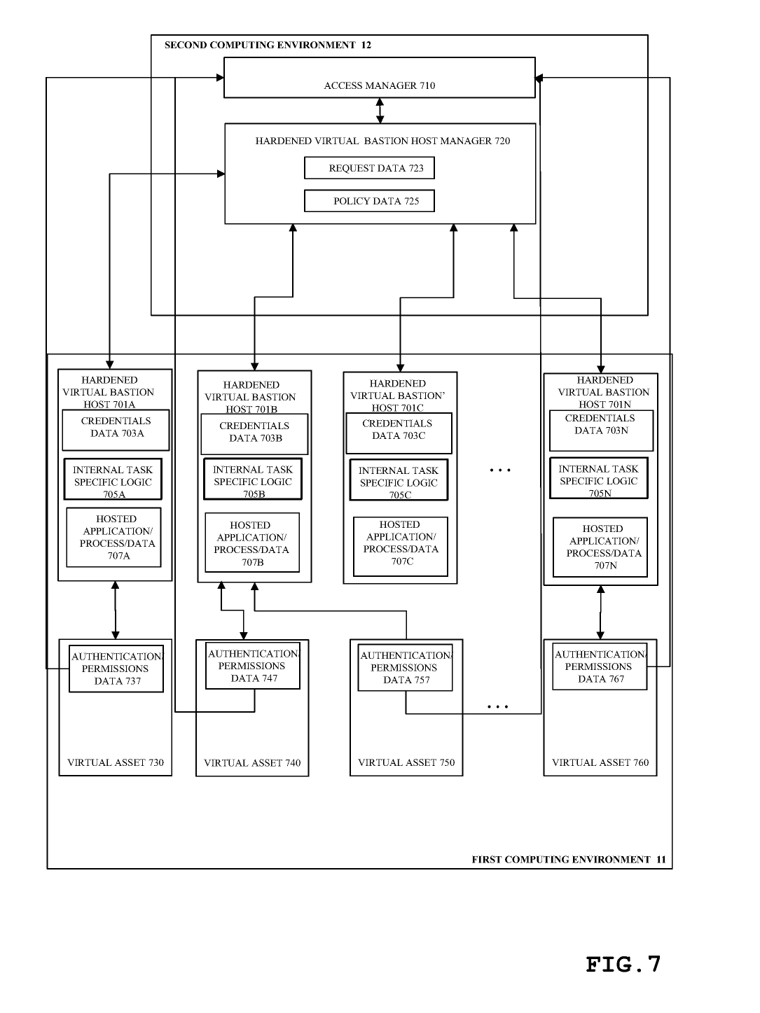

FIG. 1, FIG. 4, and FIG. 7 are functional diagrams of the interaction of various elements associated with various embodiments discussed herein. Of particular note, the various elements in FIG. 1, FIG. 4, and FIG. 7 are shown for illustrative purposes as being associated with specific computing environments, such as first computing environment 11 and second computing environment 12. However, the exemplary placement of the various elements within these environments and systems in FIG. 1, FIG. 4, and/or FIG. 7 are made for illustrative purposes only and, in various embodiments, any individual element shown FIG. 1, FIG. 4, and/or FIG. 7, or combination of elements shown in FIG. 1, FIG. 4, and/or FIG. 7, can be implemented and/or deployed on any of one or more various computing environments or systems, and/or architectural or infrastructure components, such as one or more hardware systems, one or more software systems, one or more data centers, more or more clouds or cloud types, one or more third party service capabilities, or any other computing environments, architectural, and/or infrastructure components, as discussed herein, and/or as known in the art at the time of filing, and/or as developed/made available after the time of filing.

In addition, the elements shown in FIG. 1, FIG. 4, and FIG. 7, and/or the computing environments, systems and architectural and/or infrastructure components, deploying the elements shown in FIG. 1, FIG. 4, and FIG. 7, can be under the control of, or otherwise associated with, various parties or entities, or multiple parties or entities, such as, but not limited to, the owner of a data center keeping or accessing the secrets data, a party and/or entity providing all or a portion of a cloud-based computing environment, the owner or a provider of a service, the owner or provider of one or more resources, and/or any other party and/or entity providing one or more functions, and/or any other party and/or entity as discussed herein, and/or as known in the art at the time of filing, and/or as made known after the time of filing.

In accordance with one embodiment, hardened task specific virtual hosts are provided in a first computing environment.

In one embodiment, the hardened task specific virtual hosts are virtual assets instantiated in the first computing environment. In one embodiment, the hardened task specific virtual hosts are virtual assets instantiated in a cloud computing environment.

In various embodiments, as specific illustrative examples, the hardened task specific virtual hosts can be, but are not limited to, hardened virtual data caches; hardened virtual bastion hosts; hardened virtual administrative hosts; hardened virtual forensic analysis administrative hosts; hardened virtual gateways; hardened virtual machines; hardened virtual servers; hardened databases or data stores; any hardened instances or assets in a cloud computing environment; hardened cloud computing environment access control systems; and/or any hardened virtual asset instantiated in any computing environment, as discussed herein, and/or as known in the art at the time of filing, and/or as developed/made available after the time of filing.

As used herein, the term “virtual asset” includes any virtualized entity or resource, and/or a software subsystem of an actual, or “bare metal” entity requiring access to various resources, and types of resources. In various embodiments, the virtual assets can be, but are not limited to, virtual machines, virtual servers, and instances implemented in a cloud computing environment; databases implemented, or associated with, a cloud computing environment and/or instances implemented in a cloud computing environment; services associated with, and or delivered through, a cloud computing environment; communications systems used with, part of, or provided through, a cloud computing environment; and/or any other virtualized assets and/or sub-systems of “hard metal” physical devices such as mobile devices, remote sensors, laptops, desktops, point-of-sale devices, ATMs, electronic voting machines, etc., requiring access to various resources, and/or types of resources, located within a data center, within a cloud computing environment, and/or any other physical or logical location, as discussed herein, and/or as known/available in the art at the time of filing, and/or as developed/made available after the time of filing.

In one embodiment, the hardened task specific virtual hosts are instantiated in the first computing environment using a virtual asset creation system such as a virtual asset creation template through which the creator of the hardened task specific virtual host can generate virtual host creation data such as, but not limited to, hardening logic to harden the task specific virtual hosts; internal task specific logic, such as operational logic for directing, and/or allowing, the hardened task specific virtual hosts to perform specific functions assigned to the hardened task specific virtual hosts; and hosted application/process/data assigning resources and attributes to the hardened task specific virtual hosts necessary to perform the specific functions assigned to the hardened task specific virtual hosts.

In one embodiment, by virtue of the customization of the virtual asset templates to instantiate the hardened task specific virtual hosts, the virtual asset templates are transformed into specialized virtual asset templates herein referred to as a hardened task specific virtual host creation templates. In various embodiments, the hardened task specific virtual host creation templates include hardening logic for providing enhanced security and trust in the hardened task specific virtual hosts to be instantiated using the hardened task specific virtual host creation templates, and for identifying the hardened task specific virtual host as a trusted agent generated within the first computing environment.

As used herein the term “hardening” refers to the process of providing one or more additional security measures to be applied to a virtual asset, such as such a hardened task specific virtual host, to provide protection from various forms of attack within a given computing environment and to establish a level of trust between the hardened virtual asset and another computing entity, such as, but not limited to, a hardened task specific virtual host manager, another virtual asset, an application, a data center, or any other computing entity associated with the hardened virtual asset, and/or owning/controlling/using the virtual asset.

In one embodiment, the hardened task specific virtual host hardening logic includes one or more additional, or alternative, challenges, and/or responses to challenges, that are used to authenticate the hardened task specific virtual host and to further identify the hardened task specific virtual host as a trusted agent. In one embodiment, the hardened task specific virtual host hardening logic is used or provided to other entities as part of the bootstrap handshake with those entities at the time the hardened task specific virtual host is first instantiated in the first computing environment.

As discussed below, in one embodiment, the hardened task specific virtual host hardening logic is provided to a hardened task specific virtual host manager in a second computing environment in order to authenticate the hardened task specific virtual host and identify the hardened task specific virtual host as a trusted asset in the first computing environment. In one embodiment, the hardened task specific virtual host hardening logic is provided in addition to standard authentication procedures performed with an initial set of credentials.

In one embodiment, the one or more additional or alternative challenges included in the hardened task specific virtual host hardening logic includes automatically loading specified datum from a specified storage service onto the hardened task specific virtual host and then providing the specified datum to an entity needing to confirm the identity of the hardened task specific virtual host as a trusted virtual asset.

In one embodiment, the one or more additional or alternative challenges included in the hardened task specific virtual host hardening logic includes data for reading or obtaining hardware identification data indicating the identification of the underlying hardware on which the hardened task specific virtual host is running. In one embodiment, the hardware identification data is then confirmed by comparing it with data obtained via other systems, such as a cloud provider control plane.

In one embodiment, the one or more additional or alternative challenges included in the hardened task specific virtual host hardening logic includes any authentications, challenges, or combination of authentications and/or challenges desired, and/or as discussed herein, and/or as known in the art/available at the time of filing, and/or as developed/made available after the time of filing.

Numerous means, methods, processes, procedures and systems, are known in the art for providing virtual asset hardening. Consequently, a more detailed description of specific means, methods, processes, procedures, and systems, for hardening task specific virtual hosts to create hardened task specific virtual hosts is omitted here to avoid detracting from the invention.

As noted above, in various embodiments, through the hardened task specific virtual host creation templates, each of the hardened task specific virtual hosts to be instantiated using the hardened task specific virtual host creation templates are provided internal task specific logic, such as operational logic for directing, and/or allowing, the hardened task specific virtual hosts to perform specific functions assigned to the hardened task specific virtual hosts.

As also noted above, hosted application/process/data is provided to each of hardened task specific virtual hosts, as separate logic and/or as part of the internal task specific logic provided to the hardened task specific virtual hosts, assigning resources and attributes to the hardened task specific virtual hosts necessary to perform the specific functions assigned to the hardened task specific virtual hosts.

In various embodiments, the internal task specific logic and/or the hosted application/process/data provided to a given hardened task specific virtual host depends on the specific function assigned to the hardened task specific virtual host. For example, a hardened task specific virtual host that is to function as a hardened task specific virtual administrative host may be provided with internal task specific logic including instructions for gathering data from other virtual assets and hosted application/process/data including the credentials and access rights data required to access the data associated with those virtual assets.

As another example, a hardened task specific virtual host that is to function as a hardened task specific virtual bastion host may be provided with hosted application/process/data including various data, applications, and other resources, to be used by another virtual asset at the hardened task specific virtual bastion host and internal task specific logic for authenticating the other virtual asset, or receiving authentication data regarding the other virtual asset.

As another example, a hardened task specific virtual gateway host may be provided hosted application/process/data including access data for providing a virtual asset access to data and/or other resources residing on yet another virtual asset, or another resource, and internal task specific logic for authenticating the other virtual asset, or receiving authentication data regarding the other virtual asset.

As discussed above, in various embodiments, different types, or classes, of hardened task specific virtual hosts are instantiated using different types of virtual host creation data and hosted application/process/data provided through the hardened task specific virtual host creation templates. Consequently, by providing different internal task specific logic and hosted application/process/data through the hardened task specific virtual host creation templates, the creator of a hardened task specific virtual host can easily and efficiently instantiate highly specialized hardened task specific virtual hosts to perform specific functions, and, as discussed below, then remove or delete the hardened task specific virtual hosts from the first computing environment when the specific functions assigned to the hardened task specific virtual hosts are completed. This provides for an extremely flexible, dynamic, and secure method for providing duty separation, and as many isolated environments as required to perform various tasks, without investing resources in relatively permanent systems as is currently the norm.

In various embodiments, by simply changing the internal task specific logic and/or hosted application/process/data provided to a hardened task specific virtual host through a hardened task specific virtual host creation template, the creator of the hardened task specific virtual hosts can create one, or multiple copies of, multiple different types of hardened task specific virtual hosts such as, but not limited to, hardened virtual data caches; hardened virtual bastion hosts; hardened virtual administrative hosts; hardened virtual forensic analysis administrative hosts; hardened virtual gateways; hardened virtual machines; hardened virtual servers; hardened databases or data stores; any hardened instances in a cloud computing environment; hardened cloud computing environment access control systems; and/or any hardened virtual asset instantiated in any computing environment, as discussed herein, and/or as known in the art at the time of filing, and/or as developed/made available after the time of filing.

In some embodiments, the different types of hardened task specific virtual hosts are created in advance of an identified need for the specific function assigned to hardened task specific virtual hosts. In these embodiments, one or more instances or templates of the different types of hardened task specific virtual hosts are then stored to await an identified need for the specific functions assigned to the hardened task specific virtual hosts. In these embodiments, the hardened task specific virtual hosts are then instantiated and/or deployed, in one embodiment by a hardened task specific virtual host manager, when the need for the specific function assigned the hardened task specific virtual hosts function are identified. In some embodiments, one or more copies of one or more different types of hardened task specific virtual hosts are grouped together to enable a larger task to be accomplished which requires the performance of various task required functions assigned to the one or more copies of the one or more different types of hardened task specific virtual hosts.

In other embodiments, the hardened task specific virtual hosts are instantiated only once the need for a specific function to be assigned to the hardened task specific virtual host is identified. In these embodiments, once the need for a specific function is identified, the appropriate internal task specific logic is provided via virtual host creation data generated in a hardened task specific virtual host creation template. The hardened task specific virtual host is then instantiated, in one embodiment, through a hardened task specific virtual host manager.

As noted above, in various embodiments, a hardened task specific virtual host manager is used to instantiate, and/or deploy, the hardened task specific virtual hosts. In one embodiment, the hardened task specific virtual host manager instantiates, and/or deploys, the hardened task specific virtual hosts in accordance with one or more security policies, referred to herein as hardened task specific virtual host deployment policies, and/or hardened task specific virtual host deployment policy data.

In various embodiments, the hardened task specific virtual host deployment policy data is open-endedly defined such that the hardened task specific virtual host deployment policy can be defined by the one or more parties such as, but not limited to, the owner of a data center, the owner or provider of a cloud computing environment, the owner or a provider of a service, the owner or provider of one or more resources, and/or any other party. In this way, using the disclosed process for providing a hardened task specific virtual host, the hardened task specific virtual host deployment policy can be tailored to the specific needs of the one or more parties. In addition, hardened task specific virtual host deployment policies can be added, modified, or deleted, as needed to meet the needs of the one or more parties.

In some embodiments, once a determination is made that a given hardened task specific virtual host has performed the specific function assigned to that given hardened task specific virtual host, the given hardened task specific virtual host is recalled and stored for reuse when the need for the specific function assigned to the given hardened task specific virtual host is identified. In other embodiments, once a determination is made that a given hardened task specific virtual host has performed the specific function assigned to that given hardened task specific virtual host, the given hardened task specific virtual host is destroyed or deleted. Either way, any potential security weakness represented by the continued deployment of the hardened task specific virtual hosts after the specific function assigned to the hardened task specific virtual hosts are completed is eliminated.

Using the hardened task specific virtual hosts described herein, a flexible and dynamic ability to perform various functions is provided in such a way that the allocation of resources required to perform a given task in a duty separated manner, and/or, in a virtually unlimited number of isolated environments, is minimized. This provides a level of security and efficiency that is currently unknown.

Shown in FIG. 1 are hardened task specific virtual hosts 101A, 101B, and 101C through 101N. As discussed above, in various embodiments, each of hardened task specific virtual hosts 101A, 101B, and 101C through 101N is a different type of hardened task specific virtual host instantiated for performing a different specific function. In other embodiments, hardened task specific virtual hosts 101A, 101B, and 101C through 101N can all be the same type of hardened task specific virtual host, or any two or more of hardened task specific virtual hosts 101A, 101B, and 101C through 101N can be of the same type of hardened task specific virtual host.

As seen in FIG. 1, in this specific illustrative example, hardened task specific virtual hosts 101A, 101B, and 101C through 101N are instantiated in first computing environment 11, such as, in one embodiment, a cloud computing environment.

As also seen in FIG. 1, in one embodiment hardened task specific virtual hosts 101A, 101B, and 101C through 101N are controlled or managed by hardened task specific virtual host manager 120 implemented, in this specific illustrative example, in second computing environment 12. As seen in FIG. 1, hardened task specific virtual host manager 120 includes task data 123 representing a task that includes task required functions that have been assigned to one or more of hardened task specific virtual hosts 101A, 101B, and 101C through 101N. In addition, in this specific illustrative example, hardened task specific virtual host manager 120 also includes hardened task specific virtual host deployment policy data, represented by policy data 125, that, in one embodiment, determines which task required functions of task data 123 are to be performed using hardened task specific virtual hosts.

As also seen in FIG. 1, each of hardened task specific virtual hosts 101A, 101B, and 101C through 101N includes credentials data 103A, 103B, and 103C through 103N, respectively, for identifying each of hardened task specific virtual hosts 101A, 101B, and 101C through 101N, and/or establishing access rights associated with each of hardened task specific virtual hosts 101A, 101B, and 101C through 101N.

As also seen in FIG. 1, each of hardened task specific virtual hosts 101A, 101B, and 101C through 101N includes internal task specific logic 105A, 105B, and 105C through 105N which includes logic for directing and/or allowing each of hardened task specific virtual hosts 101A, 101B, and 101C through 101N to perform the functions assigned to hardened task specific virtual hosts 101A, 101B, and 101C through 101N.

In addition, each of hardened task specific virtual hosts 101A, 101B, and 101C through 101N includes hosted application/process/data 107A, 107B, and 107C through 107N, representing resources and attributes assigned to hardened task specific virtual hosts 101A, 101B, and 101C through 101N and necessary to perform the specific functions assigned to the hardened task specific virtual hosts 101A, 101B, and 101C through 101N via internal task specific logic 105A, 105B, and 105C through 105N.

As also noted above, each of the hardened task specific virtual hosts is instantiated using a virtual asset creation system such as a specialized virtual asset template, herein referred to as a hardened task specific virtual host creation template.

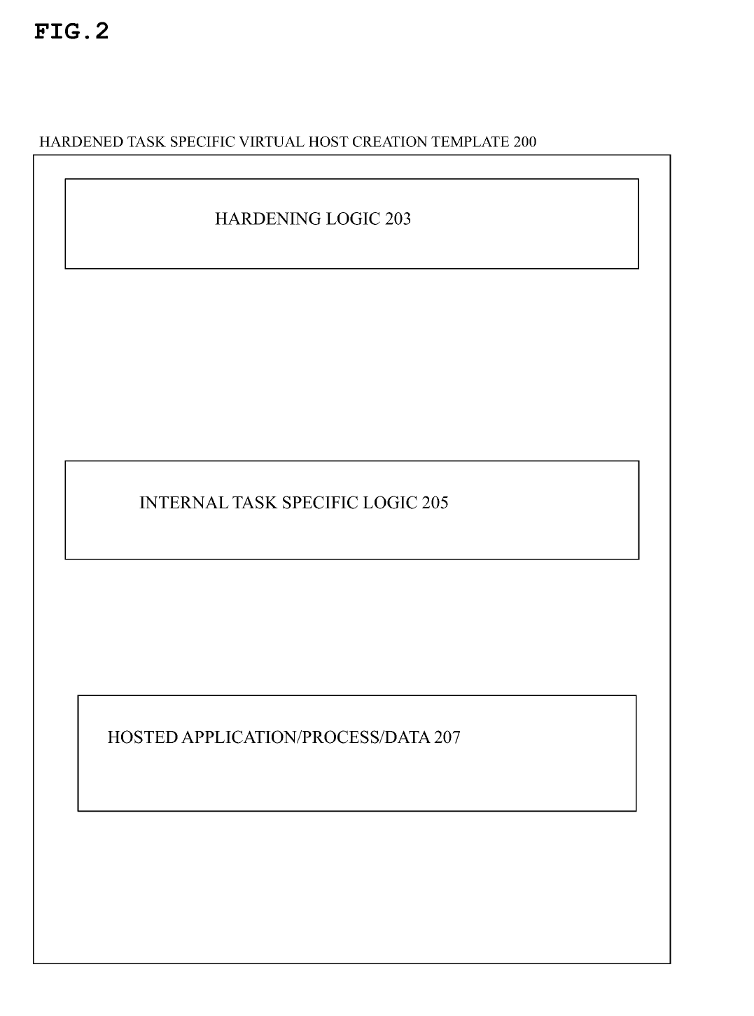

FIG. 2 is a functional diagram of part of the operational logic of a hardened task specific virtual host creation template 200 for creating a hardened task specific virtual host, such as any of the hardened task specific virtual hosts 101A, 101B, and 101C through 101N of FIG. 1, in accordance with one embodiment.

As seen in FIG. 2, in one embodiment, hardened task specific virtual host creation template 200 includes hardening logic 203 to, as discussed above, harden the task specific virtual hosts and identifying the hardened task specific virtual hosts as trusted agents deployed within the first computing environment.

As seen in FIG. 2, in one embodiment, hardened task specific virtual host creation template 200 includes internal task specific logic 205, such as operational logic for, as discussed above, directing, and/or allowing, the hardened task specific virtual hosts to perform specific functions assigned to the hardened task specific virtual hosts.

As seen in FIG. 2, in one embodiment, hardened task specific virtual host creation template 200 includes hosted application/process/data 207 assigning resources and attributes to the hardened task specific virtual hosts necessary to perform the specific functions assigned to the hardened task specific virtual hosts via internal task specific logic 205.

In one embodiment, task data is received indicating a task to be performed in the first computing environment. In one embodiment, once the task data is received, the task data is analyzed to determine the task to be performed and what task required functions, or subtasks, need to be accomplished in order to perform the task described in the task data.

In one embodiment, the task required functions are identified and then one or more hardened task specific virtual hosts capable of performing the identified task required functions are instantiated, and/or deployed, in the first computing environment.

Referring to FIG. 1, as noted, in one embodiment, hardened task specific virtual host manager 120 receives task data 123 in second computing environment 12 indicating a task to be performed in first computing environment 11 and including one or more task required functions necessary to accomplish the task indicated in task data 123. As also seen in FIG. 1, hardened task specific virtual hosts 101A, 101B, and 101C through 101N are then instantiated, and/or deployed, in first computing environment 11 by hardened task specific virtual host manager 120 in accordance with the policies indicated in policy data 125.

In various embodiments, the performance of the specific functions assigned to the deployed hardened task specific virtual hosts includes the interaction of the hardened task specific virtual hosts with other virtual assets, and/or resources, in the first computing environment. In various embodiments, these other virtual assets, and/or resources, include, but are not limited to, any virtual assets and/or resources as discussed herein, and/or as known in the art at the time of filing, and/or as developed/made available after the time of filing. In addition, in some embodiments, the resources accessed by the hardened task specific virtual hosts exist in a computing environment other than the first computing environment in which the hardened task specific virtual hosts are deployed.

Referring to FIG. 1, virtual assets 130, 140, and 150 through 160 are illustratively shown as examples of virtual assets and/or resources accessed by hardened task specific virtual hosts 101A, 101B, and 101C through 101N.

In one embodiment, once a task required function associated with a given hardened task specific virtual host is completed, the given hardened task specific virtual host is retired for later redeployment, or is deleted. As noted above, in this way any potential security risk presented by the continued deployment of a hardened task specific virtual host after the function assigned to that hardened task specific virtual host is completed is removed.

Using the process for providing and dynamically deploying hardened task specific virtual hosts discussed above, different types, or classes, of hardened task specific virtual hosts are instantiated using different types of virtual host creation data provided through the hardened task specific virtual host creation templates. Consequently, by providing different internal task specific logic through the hardened task specific virtual host creation templates, the creator of a hardened task specific virtual host can easily and efficiently instantiate highly specialized hardened task specific virtual hosts to perform specific functions, and then remove or delete the hardened task specific virtual hosts from the first computing environment when the specific functions assigned to the hardened task specific virtual hosts are completed. This provides for an extremely flexible, dynamic, and secure method for providing duty separation, and as many isolated environments as required to perform various tasks, without investing resources in relatively permanent systems as is currently the norm.

Consequently, using process for providing and dynamically deploying hardened task specific virtual hosts discussed above, a flexible and dynamic ability to perform various functions is provided in such a way as to minimize the allocation of resources required to perform a given task in a duty separated manner, and/or, in a virtually unlimited number of isolated environments. This provides a level of security and efficiency that is currently unknown.

In one embodiment, the hardened task specific virtual hosts are specialized hardened task specific virtual administrative hosts used to perform administrative tasks such as, but not limited to, data gathering related tasks, such as forensic analysis related tasks; monitoring related tasks, such as monitoring the operation of various virtual assets and resources associated with a cloud computing environment; maintenance related tasks, such as performing various scheduled and/or on-demand maintenance associated with virtual assets and resources associated with a cloud computing environment; state determination tasks, such as determining the state of a cloud computing environment by obtaining data from various virtual assets and/or resources associated with a cloud computing environment; and/or any other administrative tasks as discussed herein, and/or as known in the art at the time of filing, and/or as developed/becomes known in the art after the time of filing.

As noted above, in one embodiment, one or more types of hardened task specific virtual administrative hosts are instantiated through the generation of one or more types of virtual host creation data using a virtual asset creation system.

As also noted above, part of the virtual host creation data includes hardening logic to establish the hardened task specific virtual administrative hosts as secure and trusted agents deployed in one or more computing environments.

As also noted above, the different types of hardened task specific virtual administrative hosts are created by providing different internal task specific logic to the hardened task specific virtual administrative hosts through hardened task specific virtual administrative host creation templates.

Shown in FIG. 4 are hardened task specific virtual administrative hosts 401A, 401B, and 401C through 401N. As discussed above, in various embodiments, each of hardened task specific virtual administrative hosts 401A, 401B, and 401C through 401N is a different type of hardened task specific virtual administrative host instantiated for performing a different specific administrative function. In other embodiments, hardened task specific virtual administrative hosts 401A, 401B, and 401C through 401N can all be the same type of hardened task specific virtual administrative host, or any two or more of hardened task specific virtual administrative hosts 401A, 401B, and 401C through 401N can be of the same type of hardened task specific virtual administrative host.

As seen in FIG. 4, in this specific illustrative example, hardened task specific virtual administrative hosts 401A, 401B, and 401C through 401N are instantiated in first computing environment 11, such as, in one embodiment, a cloud computing environment.

As also seen in FIG. 4, in one embodiment hardened task specific virtual administrative hosts 401A, 401B, and 401C through 401N are controlled or managed by hardened task specific virtual administrative host manager 420 implemented, in this specific illustrative example, in second computing environment 12. As seen in FIG. 4, hardened task specific virtual administrative host manager 420 includes task data 423 representing a task that includes task required administrative functions that have been assigned to one or more of hardened task specific virtual administrative hosts 401A, 401B, and 401C through 401N. In addition, in this specific illustrative example, hardened task specific virtual administrative host manager 420 also includes hardened task specific virtual administrative host deployment policy data, represented by policy data 425, that, in one embodiment, determines which task required administrative functions of task data 423 are to be performed using hardened task specific virtual administrative hosts.

As also seen in FIG. 4, each of hardened task specific virtual administrative hosts 401A, 401B, and 401C through 401N includes credentials data 403A, 403B, and 403C through 403N, respectively, for identifying each of hardened task specific virtual administrative hosts 401A, 401B, and 401C through 401N, and/or establishing access rights associated with each of hardened task specific virtual administrative hosts 401A, 401B, and 401C through 401N.

As also seen in FIG. 4, each of hardened task specific virtual administrative hosts 401A, 401B, and 401C through 401N includes internal task specific logic 405A, 405B, and 405C through 405N which includes logic for directing and/or allowing each of hardened task specific virtual administrative hosts 401A, 401B, and 401C through 401N to perform the administrative functions assigned to hardened task specific virtual administrative hosts 401A, 401B, and 401C through 401N.

In addition, in this specific example, each of hardened task specific virtual administrative hosts 401A, 401B, and 401C through 401N includes data 431, data 441, and data 451 through data 461, representing data obtained from, or provided to, virtual assets 430, 440, and 450 through 460 in the course of performing the administrative functions required by internal task specific logic 405A, 405B, and 405C through 405N of hardened task specific virtual administrative hosts 401A, 401B, and 401C through 401N, respectfully.

As also noted above, each of the hardened task specific virtual administrative hosts is instantiated using a virtual asset creation system such as a specialized virtual asset template, herein referred to as a hardened task specific virtual administrative host creation template.

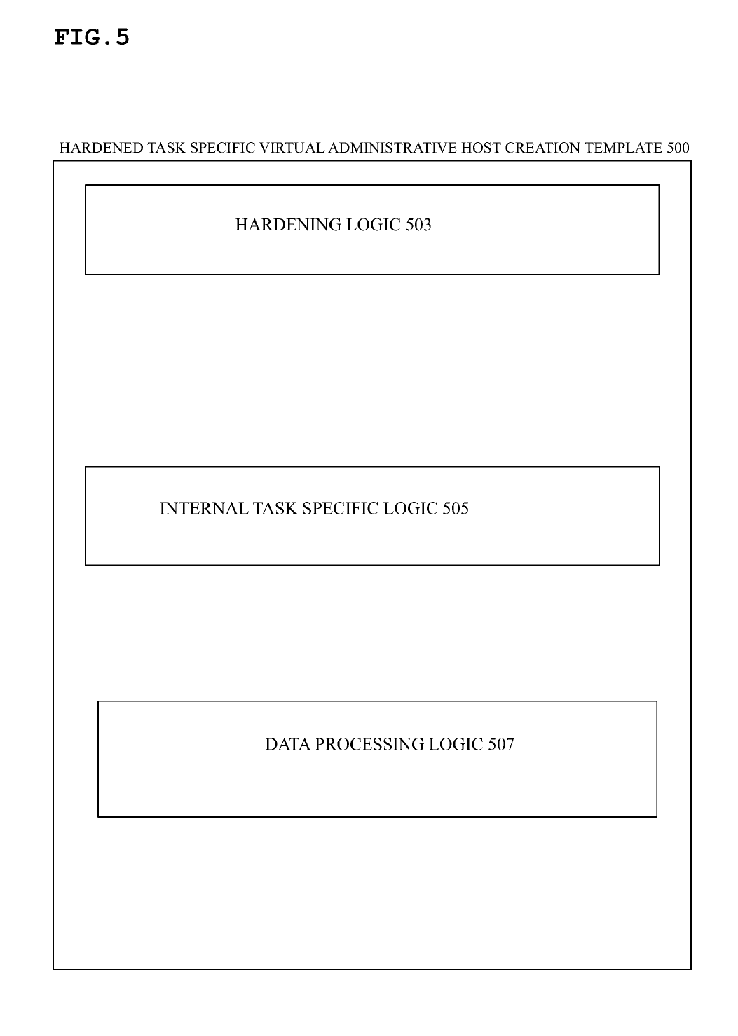

FIG. 5 is a functional diagram of part of the operational logic of a hardened task specific virtual administrative host creation template 500 for creating a hardened task specific virtual administrative host, such as any of the hardened task specific virtual administrative hosts 401A, 401B, and 401C through 401N of FIG. 4, in accordance with one embodiment.

As seen in FIG. 5, in one embodiment, hardened task specific virtual administrative host creation template 500 includes hardening logic 503 to, as discussed above, harden the task specific virtual administrative hosts and identifying the hardened task specific virtual administrative hosts as trusted agents deployed within the first computing environment.

As seen in FIG. 5, in one embodiment, hardened task specific virtual administrative host creation template 500 includes internal task specific logic 505, such as operational logic for, as discussed above, directing, and/or allowing, the hardened task specific virtual administrative hosts to perform specific administrative functions assigned to the hardened task specific virtual administrative hosts.

As seen in FIG. 5, in one embodiment, hardened task specific virtual administrative host creation template 500 includes data processing logic 507 for facilitating the obtaining data from, and/or providing data to, virtual assets and/or other resources in accordance with internal task specific logic 505.

In one embodiment, task data is received indicating an administrative task to be performed in the first computing environment. In one embodiment, once the task data is received, the task data is analyzed to determine the administrative task to be performed and what task required administrative functions, or subtasks, need to be accomplished in order to perform the administrative task described in the task data.

In one embodiment, the administrative task required functions are identified and then one or more hardened task specific virtual administrative hosts capable of performing the identified task required administrative functions are instantiated, and/or deployed, in the first computing environment.

Referring to FIG. 4, as noted, in one embodiment, hardened task specific virtual administrative host manager 420 receives task data 423 in second computing environment 12 indicating an administrative task to be performed in first computing environment 11 and including one or more task required administrative functions necessary to accomplish the task indicated in task data 423. As also seen in FIG. 4, hardened task specific virtual administrative hosts 401A, 401B, and 401C through 401N are then instantiated, and/or deployed, in first computing environment 11 by hardened task specific virtual administrative host manager 420 in accordance with the policies indicated in policy data 425.

In various embodiments, the performance of the specific administrative functions assigned to the deployed hardened task specific virtual administrative hosts includes the interaction of the hardened task specific virtual administrative hosts with other virtual assets, and/or resources, in the first computing environment. In various embodiments, these other virtual assets, and/or resources, include, but are not limited to, any virtual assets and/or resources as discussed herein, and/or as known in the art at the time of filing, and/or as developed/made available after the time of filing. In addition, in some embodiments, the resources accessed by the hardened task specific virtual administrative hosts exist in a computing environment other than the first computing environment in which the hardened task specific virtual administrative hosts are deployed.

Referring to FIG. 4, virtual assets 430, 440, and 450 through 460 are illustratively shown as examples of virtual assets and/or resources accessed by hardened task specific virtual administrative hosts 401A, 401B, and 401C through 401N.

In the specific illustrative example of FIG. 5, data 431, data 441, and data 451 through data 461 is obtained from, or provided to, virtual assets 430, 440, and 450 through 460 via hardened task specific virtual administrative hosts 401A, 401B, and 401C through 401N. In the specific illustrative example of FIG. 4, data 431, data 441, and data 451 is stored in database 490 in second computing environment 12.

In one embodiment, once a task required function associated with a given hardened task specific virtual administrative host is completed, the given hardened task specific virtual administrative host is retired for later redeployment, or is deleted. As noted above, in this way, any potential security risk presented by the continued deployment of a hardened task specific virtual administrative host after the function assigned to that hardened task specific virtual administrative host is completed is removed.

Using the process for providing and dynamically deploying hardened task specific virtual administrative hosts discussed above, different types, or classes, of hardened task specific virtual administrative hosts are instantiated using different types of virtual host creation data provided through the hardened task specific virtual administrative host creation templates. Consequently, by providing different internal task specific logic through the hardened task specific virtual administrative host creation templates, the creator of a hardened task specific virtual administrative host can easily and efficiently instantiate highly specialized hardened task specific virtual administrative hosts to perform specific functions, and then remove or delete the hardened task specific virtual administrative hosts from the first computing environment when the specific functions assigned to the hardened task specific virtual administrative hosts are completed. This provides for an extremely flexible, dynamic, and secure method for providing duty separation, and as many isolated environments as required to perform various tasks, without investing resources in relatively permanent systems as is currently the norm.

Consequently, using process for providing and dynamically deploying hardened task specific virtual administrative hosts discussed above, a flexible and dynamic ability to perform various functions is provided in such a way as to minimize the allocation of resources required to perform a given task in a duty separated manner, and/or, in a virtually unlimited number of isolated environments. This provides a level of security and efficiency that is currently unknown.

In one embodiment, the hardened task specific virtual hosts are specialized hardened task specific virtual bastion hosts used to perform data and resource access related functions such as, but not limited to, providing isolated processing sub-environments; providing gating and data access restriction functions; providing hardened caching functions; and various other functions typically associated with request data received from one of more other virtual assets in a computing environment, requesting access to data and/or one or more resources, as discussed herein, and/or as known in the art at the time of filing, and/or as developed/becomes known in the art after the time of filing.

As noted above, in one embodiment, one or more types of hardened task specific virtual bastion hosts are instantiated through the generation of one or more types of virtual host creation data using a virtual asset creation system.

As also noted above, part of the virtual host creation data includes hardening logic to establish the hardened task specific virtual bastion hosts as secure and trusted agents deployed in one or more computing environments.

As also noted above, the different types of hardened task specific virtual bastion hosts are created by providing different internal task specific logic to the hardened task specific virtual bastion hosts through hardened task specific virtual bastion host creation templates.

Shown in FIG. 7 are hardened task specific virtual bastion hosts 701A, 701B, and 701C through 701N. As discussed above, in various embodiments, each of hardened task specific virtual bastion hosts 701A, 701B, and 701C through 701N is a different type of hardened task specific virtual bastion host instantiated for performing a different specific function. In other embodiments, hardened task specific virtual bastion hosts 701A, 701B, and 701C through 701N can all be the same type of hardened task specific virtual bastion host, or any two or more of hardened task specific virtual bastion hosts 701A, 701B, and 701C through 701N can be of the same type of hardened task specific virtual bastion host.

As seen in FIG. 7, in this specific illustrative example, hardened task specific virtual bastion hosts 701A, 701B, and 701C through 701N are instantiated in first computing environment 11, such as, in one embodiment, a cloud computing environment.

As also seen in FIG. 7, in one embodiment hardened task specific virtual bastion hosts 701A, 701B, and 701C through 701N are controlled or managed by hardened task specific virtual bastion host manager 720 implemented, in this specific illustrative example, in second computing environment 12. As seen in FIG. 7, hardened task specific virtual bastion host manager 720 includes request data 723 representing a request for access to one or more assets and/or resources that includes request related functions that have been assigned to one or more of hardened task specific virtual bastion hosts 701A, 701B, and 701C through 701N. In addition, in this specific illustrative example, hardened task specific virtual bastion host manager 720 also includes hardened task specific virtual bastion host deployment policy data, represented by policy data 725, that, in one embodiment, determines which request related functions associated with request data 723 are to be performed using hardened task specific virtual bastion hosts.

As also seen in FIG. 7, each of hardened task specific virtual bastion hosts 701A, 701B, and 701C through 701N includes credentials data 703A, 703B, and 703C through 703N, respectively, for identifying each of hardened task specific virtual bastion hosts 701A, 701B, and 701C through 701N, and/or establishing access rights associated with each of hardened task specific virtual bastion hosts 701A, 701B, and 701C through 701N.

As also seen in FIG. 7, each of hardened task specific virtual bastion hosts 701A, 701B, and 701C through 701N includes internal task specific logic 705A, 705B, and 705C through 705N which includes logic for directing and/or allowing each of hardened task specific virtual bastion hosts 701A, 701B, and 701C through 701N to perform the functions assigned to hardened task specific virtual bastion hosts 701A, 701B, and 701C through 701N.

In addition, each of hardened task specific virtual bastion hosts 701A, 701B, and 701C through 701N includes hosted application/process/data 707A, 707B, and 707C through 707N, representing resources and attributes assigned to hardened task specific virtual bastion hosts 701A, 701B, and 701C through 701N and necessary to perform the specific functions assigned to the hardened task specific virtual bastion hosts 701A, 701B, and 701C through 701N via internal task specific logic 705A, 705B, and 705C through 705N

As also noted above, each of the hardened task specific virtual bastion hosts is instantiated using a virtual asset creation system such as a specialized virtual asset template, herein referred to as a hardened task specific virtual bastion host creation template.

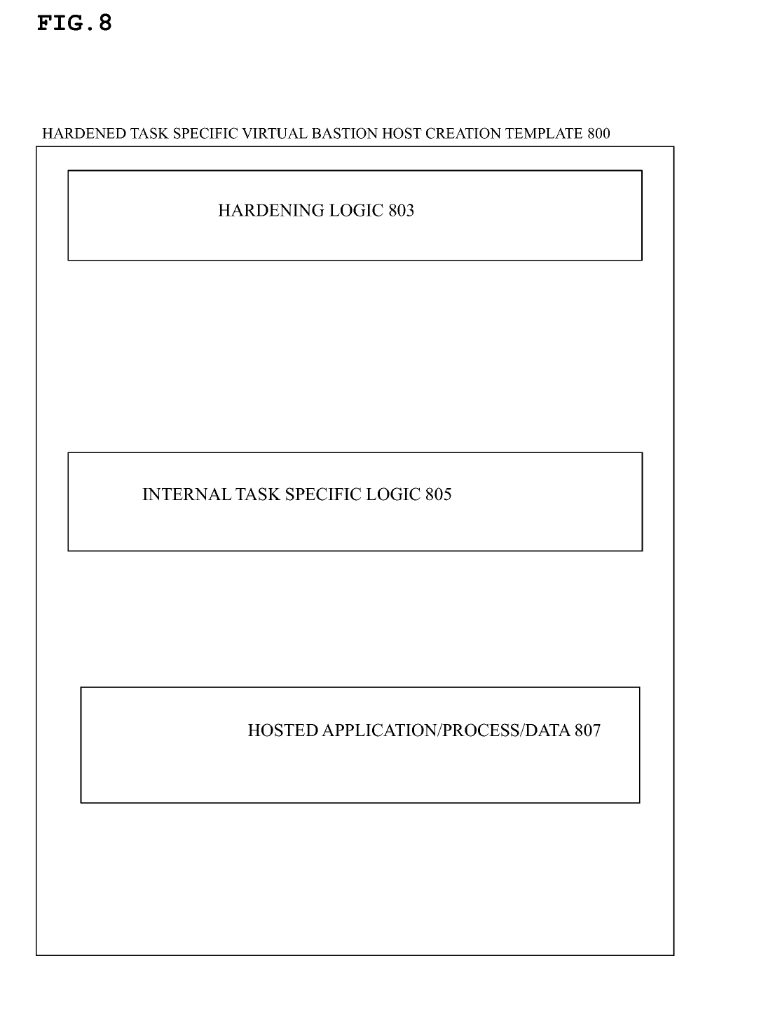

FIG. 8 is a functional diagram of part of the operational logic of a hardened task specific virtual bastion host creation template 800 for creating a hardened task specific virtual bastion host, such as any of the hardened task specific virtual bastion hosts 701A, 701B, and 701C through 701N of FIG. 7, in accordance with one embodiment.

As seen in FIG. 8, in one embodiment, hardened task specific virtual bastion host creation template 800 includes hardening logic 803 to, as discussed above, harden the task specific virtual bastion hosts and identifying the hardened task specific virtual bastion hosts as trusted agents deployed within the first computing environment.

As seen in FIG. 8, in one embodiment, hardened task specific virtual bastion host creation template 800 includes internal task specific logic 805, such as operational logic for, as discussed above, directing, and/or allowing, the hardened task specific virtual bastion hosts to perform specific functions assigned to the hardened task specific virtual bastion hosts.

As seen in FIG. 8, in one embodiment, hardened task specific virtual bastion host creation template 800 includes hosted application/process/data 807 assigning resources and attributes to the hardened task specific virtual bastion hosts necessary to perform the specific functions assigned to the hardened task specific virtual bastion hosts via internal task specific logic 805.

In one embodiment, request data is received indicating a request for access to one or more virtual assets, or resources from a virtual asset, or other asset, in the first computing environment.

In one embodiment, the requesting virtual asset, or other requesting asset, requesting access to one or more resources is first authenticated, in one embodiment, by an access manager.

Referring to FIG. 7, request data 723 is received from one or more virtual assets represented by virtual asset 730, virtual asset 740, and virtual asset 750 through virtual asset 760, by hardened virtual bastion host manager 720. In one embodiment, at least part of request data 723 is also forwarded to access manager 710 which authenticates the requesting virtual assets of virtual asset 730, virtual asset 740, and virtual asset 750 through virtual asset 760 using authentication permissions data 737, and/or authentication permissions data 747, and/or authentication permissions data 757 through authentication permissions data 767, respectively.

In one embodiment, once the request data is received, the request data is analyzed to determine the access being requested and what request related functions, or tasks, are needed to provide the requested access in accordance with the one or more data and resource access policies.

In one embodiment, the request related functions are identified and then one or more hardened task specific virtual bastion hosts capable of performing the identified request related functions are instantiated, and/or deployed, in the first computing environment.

Referring to FIG. 7, as noted, in one embodiment, hardened task specific virtual bastion host manager 720 receives request data 723 in second computing environment 12 indicating one or more request related functions to be performed in first computing environment 11 that are necessary to provide the access indicated in request data 723 in accordance with the access policies represented by policy data 725. As also seen in FIG. 7, hardened task specific virtual bastion hosts 701A, 701B, and 701C through 701N are then instantiated, and/or deployed, in first computing environment 11 by hardened task specific virtual bastion host manager 720 in accordance with the policies indicated in policy data 725.

In various embodiments, the performance of the specific request related functions assigned to the deployed hardened task specific virtual bastion hosts includes the interaction of the hardened task specific virtual bastion hosts with other virtual assets, and/or resources, in the first computing environment. In various embodiments, these other virtual assets, and/or resources, include, but are not limited to, any virtual assets and/or resources as discussed herein, and/or as known in the art at the time of filing, and/or as developed/made available after the time of filing. In addition, in some embodiments, the resources accessed by the hardened task specific virtual bastion hosts exist in a computing environment other than the first computing environment in which the hardened task specific virtual bastion hosts are deployed.

Referring to FIG. 7, virtual assets 730, 740, and 750 through 760 are illustratively shown as examples of virtual assets and/or resources associated with hardened task specific virtual bastion hosts 701A, 701B, and 701C through 701N.

In the specific illustrative example of FIG. 8, virtual asset 730 is provided access to hosted application/process/data 707A through hardened virtual bastion host 701A; virtual asset 740 and virtual asset 750 are provided access to hosted application/process/data 707B through hardened virtual bastion host 701B; and virtual asset 760 is provided access to hosted application/process/data 707N through hardened virtual bastion host 701N.

In one embodiment, once the request related function associated with a given hardened task specific virtual bastion host is completed, the given hardened task specific virtual bastion host is retired for later redeployment, or is deleted. As noted above, in this way, any potential security risk presented by the continued deployment of a hardened task specific virtual bastion host after the function assigned to that hardened task specific virtual bastion host is completed is removed.

Using the process for providing and dynamically deploying hardened task specific virtual bastion hosts discussed above, different types, or classes, of hardened task specific virtual bastion hosts are instantiated using different types of virtual host creation data provided through the hardened task specific virtual bastion host creation templates. Consequently, by providing different internal task specific logic through the hardened task specific virtual bastion host creation templates, the creator of a hardened task specific virtual bastion host can easily and efficiently instantiate highly specialized hardened task specific virtual bastion hosts to perform specific functions in an isolated environment, and then remove or delete the hardened task specific virtual bastion hosts from the first computing environment when the specific functions assigned to the hardened task specific virtual bastion hosts are completed. This provides for an extremely flexible, dynamic, and secure method for providing duty separation, and as many isolated environments as required to perform various tasks, without investing resources in relatively permanent systems as is currently the norm.

Consequently, using process for providing and dynamically deploying hardened task specific virtual bastion hosts discussed above, a flexible and dynamic ability to perform various functions is provided in such a way as to minimize the allocation of resources required to perform a given task in a duty separated manner, and/or, in a virtually unlimited number of isolated environments. This provides a level of security and efficiency that is currently unknown.

In the discussion above, certain aspects of one embodiment include processes, sub-processes, steps, operations and/or instructions described herein for illustrative purposes in a particular order and/or grouping. However, the particular order and/or grouping shown and discussed herein are illustrative only and not limiting. Those of skill in the art will recognize that other orders and/or grouping of the processes, sub-processes, steps, operations and/or instructions are possible and, in some embodiments, one or more of the processes, sub-processes, steps, operations and/or instructions discussed above can be combined and/or deleted. In addition, portions of one or more of the processes, sub-processes, steps, operations and/or instructions can be re-grouped as portions of one or more other of processes, sub-processes, steps, operations and/or instructions discussed herein. Consequently, the particular order and/or grouping of the processes, sub-processes, steps, operations and/or instructions discussed herein do not limit the scope of the invention as claimed below.

### Process

In accordance with one embodiment, a method and system for providing and dynamically deploying hardened task specific virtual hosts includes generating virtual host creation data through a virtual asset creation system. In one embodiment, the virtual host creation data is used to instantiate a hardened task specific virtual host in a first computing environment. In one embodiment, the virtual host creation data includes hardening logic for providing enhanced security and trust for the hardened task specific virtual host and internal task specific logic for directing and/or allowing the hardened task specific virtual host to perform a specific function assigned to the hardened task specific virtual host.

In one embodiment, task data is received indicating a task to be performed in the first computing environment. In one embodiment, the task data is analyzed and a determination is made that the task to be performed in the first computing environment requires the performance of the specific function assigned to the hardened task specific virtual host. In one embodiment and the hardened task specific virtual host is then automatically instantiated and/or deployed in the first computing environment.

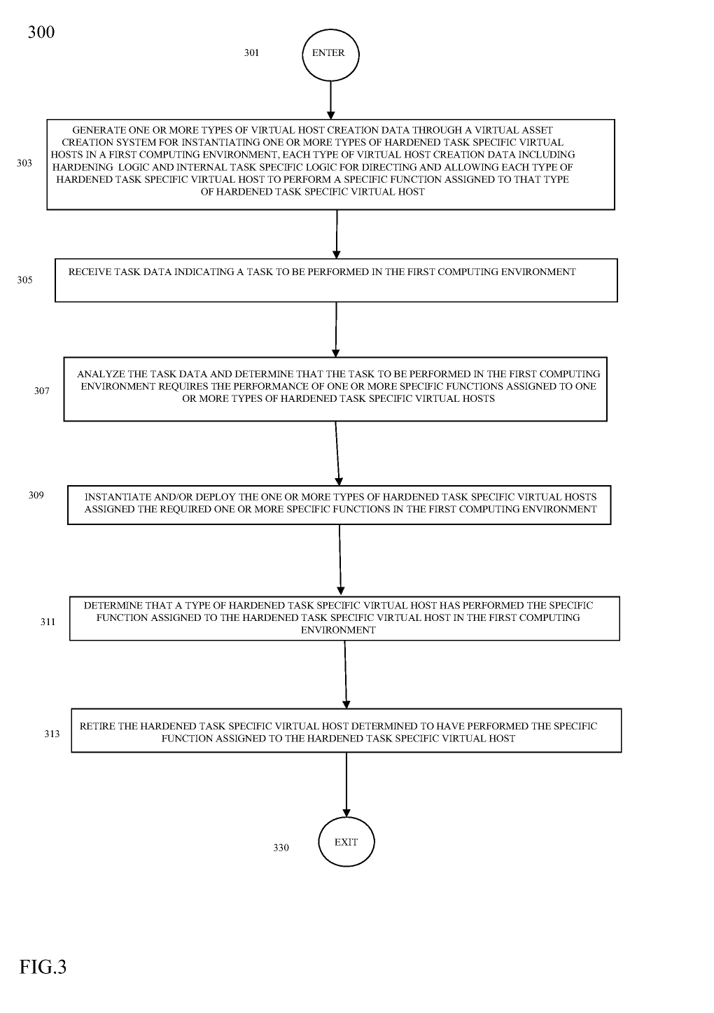

FIG. 3 is a flow chart of a process 300 for providing and dynamically deploying hardened task specific virtual hosts in accordance with one embodiment. In one embodiment, process 300 for providing and dynamically deploying hardened task specific virtual hosts begins at ENTER OPERATION 301 of FIG. 3 and process flow proceeds to GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL HOSTS IN A FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL HOST TO PERFORM A SPECIFIC FUNCTION ASSIGNED TO THAT TYPE OF HARDENED TASK SPECIFIC VIRTUAL HOST OPERATION 303.

In one embodiment, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL HOSTS IN A FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL HOST TO PERFORM A SPECIFIC FUNCTION ASSIGNED TO THAT TYPE OF HARDENED TASK SPECIFIC VIRTUAL HOST OPERATION 303 one or more hardened task specific virtual hosts are made available in a first computing environment.

In one embodiment, the hardened task specific virtual hosts of GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL HOSTS IN A FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL HOST TO PERFORM A SPECIFIC FUNCTION ASSIGNED TO THAT TYPE OF HARDENED TASK SPECIFIC VIRTUAL HOST OPERATION 303 are virtual assets instantiated in the first computing environment. In one embodiment, the hardened task specific virtual hosts are virtual assets instantiated in a cloud computing environment.

In various embodiments, as specific illustrative examples, the hardened task specific virtual hosts can be, but are not limited to, hardened virtual data caches; hardened virtual bastion hosts; hardened virtual administrative hosts; hardened virtual forensic analysis administrative hosts; hardened virtual gateways; hardened virtual machines; hardened virtual servers; hardened databases or data stores; any hardened instances in a cloud computing environment; hardened cloud computing environment access control systems; and/or any hardened virtual asset instantiated in any computing environment, as discussed herein, and/or as known in the art at the time of filing, and/or as developed/made available after the time of filing.

In one embodiment, the hardened task specific virtual hosts are instantiated in the first computing environment using a virtual asset creation system such as a virtual asset creation template through which the creator of the hardened task specific virtual host can generate virtual host creation data such as, but not limited to, hardening logic to harden the task specific virtual hosts; internal task specific logic, such as operational logic for directing, and/or allowing, the hardened task specific virtual hosts to perform specific functions assigned to the hardened task specific virtual hosts; and hosted application/process/data assigning resources and attributes to the hardened task specific virtual hosts necessary to perform the specific functions assigned to the hardened task specific virtual hosts.

In one embodiment, once the virtual asset templates are customized to instantiate the hardened task specific virtual hosts, the virtual asset templates are transformed into specialized virtual asset templates herein referred to as a hardened task specific virtual host creation templates. In various embodiments, the hardened task specific virtual host creation templates include hardening logic for providing enhanced security and trust in the hardened task specific virtual hosts to be instantiated using the hardened task specific virtual host creation templates, and for identifying the hardened task specific virtual host as a trusted agent generated within the first computing environment.

As used herein the term “hardened” refers to the process of providing one or more additional security measures to be applied to a virtual asset, such as such a hardened task specific virtual host, to provide protection from various forms of attack within a given computing environment and to establish a level of trust between the hardened virtual asset and another computing entity, such as, but not limited to, a hardened task specific virtual host manager, another virtual asset, an application, a data center, or any other computing entity associated with the hardened virtual asset, and/or owning/controlling/using the virtual asset.

Numerous means, methods, processes, procedures and systems, are known in the art for providing virtual asset hardening. Consequently, a more detailed description of specific means, methods, processes, procedures, and systems, for hardening task specific virtual hosts to create hardened task specific virtual hosts is omitted here to avoid detracting from the invention.

As noted above, in various embodiments, through the hardened task specific virtual host creation templates, each of the hardened task specific virtual hosts to be instantiated using the hardened task specific virtual host creation templates are provided internal task specific logic, such as operational logic for directing, and/or allowing, the hardened task specific virtual hosts to perform specific functions assigned to the hardened task specific virtual hosts.

As also noted above, hosted application/process/data is provided to each of hardened task specific virtual hosts, as separate logic and/or as part of the internal task specific logic provided to the hardened task specific virtual hosts, assigning resources and attributes to the hardened task specific virtual hosts necessary to perform the specific functions assigned to the hardened task specific virtual hosts.

In various embodiments, the internal task specific logic and hosted application/process/data provided to a given hardened task specific virtual host depends on the specific function assigned to the hardened task specific virtual host.

For example, a hardened task specific virtual host that is to function as a hardened task specific virtual administrative host may be provided with internal task specific logic including instructions for gathering data from other virtual assets and hosted application/process/data including the credentials and access rights data required to access the data associated with those virtual assets.

As another example, a hardened task specific virtual host that is to function as a hardened task specific virtual bastion host may be provided with hosted application/process/data including various data, applications, and other resources, to be used by another virtual asset at the hardened task specific virtual bastion host and internal task specific logic for authenticating the other virtual asset, or receiving authentication data regarding the other virtual asset.

As another example, a hardened task specific virtual gateway host may be provided hosted application/process/data including access data for providing a virtual asset access to data and/or other resources residing on yet another virtual asset, or another resource, and internal task specific logic for authenticating the other virtual asset, or receiving authentication data regarding the other virtual asset.

As discussed above, in various embodiments, different types, or classes, of hardened task specific virtual hosts are instantiated using different types of virtual host creation data provided through the hardened task specific virtual host creation templates. Consequently, by providing different internal task specific logic through the hardened task specific virtual host creation templates, the creator of a hardened task specific virtual host can easily and efficiently instantiate highly specialized hardened task specific virtual hosts to perform specific functions, and, as discussed below, then remove or delete the hardened task specific virtual hosts from the first computing environment when the specific functions assigned to the hardened task specific virtual hosts are completed. This provides for an extremely flexible, dynamic, and secure method for providing duty separation, and as many isolated environments as required to perform various tasks, without investing resources in relatively permanent systems as is currently the norm.

In various embodiments, by simply changing the internal task specific logic provided to a hardened task specific virtual host through a hardened task specific virtual host creation template, the creator of the hardened task specific virtual hosts can create one, or multiple copies of, multiple different types of hardened task specific virtual hosts such as, but not limited to, hardened virtual data caches; hardened virtual bastion hosts; hardened virtual administrative hosts; hardened virtual forensic analysis administrative hosts; hardened virtual gateways; hardened virtual machines; hardened virtual servers; hardened databases or data stores; any hardened instances in a cloud computing environment; hardened cloud computing environment access control systems; and/or any hardened virtual asset instantiated in any computing environment, as discussed herein, and/or as known in the art at the time of filing, and/or as developed/made available after the time of filing.

In some embodiments, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL HOSTS IN A FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL HOST TO PERFORM A SPECIFIC FUNCTION ASSIGNED TO THAT TYPE OF HARDENED TASK SPECIFIC VIRTUAL HOST OPERATION 303 the different types of hardened task specific virtual hosts or templates are created or instantiated in advance of an identified need for the specific function assigned to hardened task specific virtual hosts.

In these embodiments, one or more instances of the different types of hardened task specific virtual hosts are then stored to await an identified need for the specific functions assigned to the hardened task specific virtual hosts. In these embodiments, the hardened task specific virtual hosts are then deployed, in one embodiment by a hardened task specific virtual host manager, when the need for the specific function assigned the hardened task specific virtual hosts function is identified. In some embodiments, one or more copies of one or more different types of hardened task specific virtual hosts are grouped together according to a larger task which requires the performance of various task required functions assigned to the one or more copies of the one or more different types of hardened task specific virtual hosts.

In other embodiments, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL HOSTS IN A FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL HOST TO PERFORM A SPECIFIC FUNCTION ASSIGNED TO THAT TYPE OF HARDENED TASK SPECIFIC VIRTUAL HOST OPERATION 303 the hardened task specific virtual hosts are instantiated only once the need for a specific function to be assigned to the hardened task specific virtual host is identified. In these embodiments, once the need for a specific function is identified, the appropriate internal task specific logic is provided via virtual host creation data generated in a hardened task specific virtual host creation template. The hardened task specific virtual host is then instantiated, in one embodiment, through a hardened task specific virtual host manager.

Using the hardened task specific virtual hosts described herein, a flexible and dynamic ability to perform various functions is provided in such a way that the allocation of resources required to perform a given task in a duty separated manner, and/or, in a virtually unlimited number of isolated environments, is minimized. This provides a level of security and efficiency that is currently unknown.

As noted above, in one embodiment, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL HOSTS IN A FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL HOST TO PERFORM A SPECIFIC FUNCTION ASSIGNED TO THAT TYPE OF HARDENED TASK SPECIFIC VIRTUAL HOST OPERATION 303 one or more instances of one or more types of hardened task specific virtual hosts are instantiated through the generation of one or more types of virtual host creation data using a virtual asset creation system.

As also noted above, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL HOSTS IN A FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL HOST TO PERFORM A SPECIFIC FUNCTION ASSIGNED TO THAT TYPE OF HARDENED TASK SPECIFIC VIRTUAL HOST OPERATION 303 part of the virtual host creation data includes hardening logic to establish the hardened task specific virtual hosts as secure and trusted agents in one or more computing environments.

As also noted above, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL HOSTS IN A FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL HOST TO PERFORM A SPECIFIC FUNCTION ASSIGNED TO THAT TYPE OF HARDENED TASK SPECIFIC VIRTUAL HOST OPERATION 303 the different types of hardened task specific virtual hosts are created by providing different internal task specific logic to the hardened task specific virtual hosts through hardened task specific virtual host creation templates.

In one embodiment, once one or more hardened task specific virtual hosts are made available for deployment to a first computing environment at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL HOSTS IN A FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL HOST TO PERFORM A SPECIFIC FUNCTION ASSIGNED TO THAT TYPE OF HARDENED TASK SPECIFIC VIRTUAL HOST OPERATION 303 process flow proceeds to RECEIVE TASK DATA INDICATING A TASK TO BE PERFORMED IN THE FIRST COMPUTING ENVIRONMENT OPERATION 305.

In one embodiment, at RECEIVE TASK DATA INDICATING A TASK TO BE PERFORMED IN THE FIRST COMPUTING ENVIRONMENT OPERATION 305 task data is received indicating a task to be performed in the first computing environment.

In various embodiments, the task data received at RECEIVE TASK DATA INDICATING A TASK TO BE PERFORMED IN THE FIRST COMPUTING ENVIRONMENT OPERATION 305 represents any one of numerous tasks to be performed in the first computing environment such as, but not limited to, tasks involving the administration and/or coordination of the gathering of data from various sources; tasks involving providing and controlling access to data and resources; tasks involving maintenance of various virtual assets; tasks involving the monitoring of various virtual assets; and/or virtually any tasks to be performed on, or with, one or more virtual assets and/or resources in one or more computing environments.

In large part due to the almost unlimited types of hardened task specific virtual hosts that can be instantiated and deployed at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL HOSTS IN A FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL HOST TO PERFORM A SPECIFIC FUNCTION ASSIGNED TO THAT TYPE OF HARDENED TASK SPECIFIC VIRTUAL HOST OPERATION 303, the types of tasks that can be accomplished using the hardened task specific virtual hosts described herein is virtually unlimited.

In one embodiment, once task data is received indicating a task to be performed in the first computing environment at RECEIVE TASK DATA INDICATING A TASK TO BE PERFORMED IN THE FIRST COMPUTING ENVIRONMENT OPERATION 305, process flow proceeds to ANALYZE THE TASK DATA AND DETERMINE THAT THE TASK TO BE PERFORMED IN THE FIRST COMPUTING ENVIRONMENT REQUIRES THE PERFORMANCE OF ONE OR MORE SPECIFIC FUNCTIONS ASSIGNED TO ONE OR MORE TYPES OF HARDENED TASK SPECIFIC VIRTUAL HOSTS OPERATION 307.

In one embodiment, at ANALYZE THE TASK DATA AND DETERMINE THAT THE TASK TO BE PERFORMED IN THE FIRST COMPUTING ENVIRONMENT REQUIRES THE PERFORMANCE OF ONE OR MORE SPECIFIC FUNCTIONS ASSIGNED TO ONE OR MORE TYPES OF HARDENED TASK SPECIFIC VIRTUAL HOSTS OPERATION 307 the task data of RECEIVE TASK DATA INDICATING A TASK TO BE PERFORMED IN THE FIRST COMPUTING ENVIRONMENT OPERATION 305 is analyzed to determine the task to be performed and what task required functions, or subtasks, need to be accomplished in order to perform the task described in the task data.

In one embodiment, at ANALYZE THE TASK DATA AND DETERMINE THAT THE TASK TO BE PERFORMED IN THE FIRST COMPUTING ENVIRONMENT REQUIRES THE PERFORMANCE OF ONE OR MORE SPECIFIC FUNCTIONS ASSIGNED TO ONE OR MORE TYPES OF HARDENED TASK SPECIFIC VIRTUAL HOSTS OPERATION 307 one the task required functions are identified, and one or more hardened task specific virtual hosts of GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL HOSTS IN A FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL HOST TO PERFORM A SPECIFIC FUNCTION ASSIGNED TO THAT TYPE OF HARDENED TASK SPECIFIC VIRTUAL HOST OPERATION 303 capable of performing the identified task required functions are also identified.

In one embodiment, once the task data is analyzed to determine the task to be performed and what task required functions, or subtasks, need to be accomplished in order to perform the task described in the task data, and one or more hardened task specific virtual hosts capable of performing the identified task required functions are identified at ANALYZE THE TASK DATA AND DETERMINE THAT THE TASK TO BE PERFORMED IN THE FIRST COMPUTING ENVIRONMENT REQUIRES THE PERFORMANCE OF ONE OR MORE SPECIFIC FUNCTIONS ASSIGNED TO ONE OR MORE TYPES OF HARDENED TASK SPECIFIC VIRTUAL HOSTS OPERATION 307, process flow proceeds to INSTANTIATE AND/OR DEPLOY THE ONE OR MORE TYPES OF HARDENED TASK SPECIFIC VIRTUAL HOSTS ASSIGNED THE REQUIRED ONE OR MORE SPECIFIC FUNCTIONS IN THE FIRST COMPUTING ENVIRONMENT OPERATION 309.

In one embodiment, at INSTANTIATE AND/OR DEPLOY THE ONE OR MORE TYPES OF HARDENED TASK SPECIFIC VIRTUAL HOSTS ASSIGNED THE REQUIRED ONE OR MORE SPECIFIC FUNCTIONS IN THE FIRST COMPUTING ENVIRONMENT OPERATION 309 the one or more hardened task specific virtual hosts capable of performing the identified task required functions identified at ANALYZE THE TASK DATA AND DETERMINE THAT THE TASK TO BE PERFORMED IN THE FIRST COMPUTING ENVIRONMENT REQUIRES THE PERFORMANCE OF ONE OR MORE SPECIFIC FUNCTIONS ASSIGNED TO ONE OR MORE TYPES OF HARDENED TASK SPECIFIC VIRTUAL HOSTS OPERATION 307 are instantiated, and/or deployed, in the first computing environment.

As noted above, In some embodiments, the different types of hardened task specific virtual hosts are instantiated at INSTANTIATE AND/OR DEPLOY THE ONE OR MORE TYPES OF HARDENED TASK SPECIFIC VIRTUAL HOSTS ASSIGNED THE REQUIRED ONE OR MORE SPECIFIC FUNCTIONS IN THE FIRST COMPUTING ENVIRONMENT OPERATION 309 in advance of an identified need for the specific function assigned to hardened task specific virtual hosts at ANALYZE THE TASK DATA AND DETERMINE THAT THE TASK TO BE PERFORMED IN THE FIRST COMPUTING ENVIRONMENT REQUIRES THE PERFORMANCE OF ONE OR MORE SPECIFIC FUNCTIONS ASSIGNED TO ONE OR MORE TYPES OF HARDENED TASK SPECIFIC VIRTUAL HOSTS OPERATION 307.

In these embodiments, one or more instances of the different types of hardened task specific virtual hosts are then stored to await an identified need for the specific functions assigned to the hardened task specific virtual hosts at ANALYZE THE TASK DATA AND DETERMINE THAT THE TASK TO BE PERFORMED IN THE FIRST COMPUTING ENVIRONMENT REQUIRES THE PERFORMANCE OF ONE OR MORE SPECIFIC FUNCTIONS ASSIGNED TO ONE OR MORE TYPES OF HARDENED TASK SPECIFIC VIRTUAL HOSTS OPERATION 307. In these embodiments, the hardened task specific virtual hosts are then deployed at INSTANTIATE AND/OR DEPLOY THE ONE OR MORE TYPES OF HARDENED TASK SPECIFIC VIRTUAL HOSTS ASSIGNED THE REQUIRED ONE OR MORE SPECIFIC FUNCTIONS IN THE FIRST COMPUTING ENVIRONMENT OPERATION 309, in one embodiment by a hardened task specific virtual host manager, when the need for the specific function assigned the hardened task specific virtual hosts function is identified.

In some embodiments, one or more instances of one or more different types of hardened task specific virtual hosts are grouped together at INSTANTIATE AND/OR DEPLOY THE ONE OR MORE TYPES OF HARDENED TASK SPECIFIC VIRTUAL HOSTS ASSIGNED THE REQUIRED ONE OR MORE SPECIFIC FUNCTIONS IN THE FIRST COMPUTING ENVIRONMENT OPERATION 309 according to a larger task which requires the performance of various task required functions assigned to the one or more instances of the one or more different types of hardened task specific virtual hosts.

In other embodiments, the hardened task specific virtual hosts are instantiated at INSTANTIATE AND/OR DEPLOY THE ONE OR MORE TYPES OF HARDENED TASK SPECIFIC VIRTUAL HOSTS ASSIGNED THE REQUIRED ONE OR MORE SPECIFIC FUNCTIONS IN THE FIRST COMPUTING ENVIRONMENT OPERATION 309 only once the need for a specific function to be assigned to the hardened task specific virtual host is identified at ANALYZE THE TASK DATA AND DETERMINE THAT THE TASK TO BE PERFORMED IN THE FIRST COMPUTING ENVIRONMENT REQUIRES THE PERFORMANCE OF ONE OR MORE SPECIFIC FUNCTIONS ASSIGNED TO ONE OR MORE TYPES OF HARDENED TASK SPECIFIC VIRTUAL HOSTS OPERATION 307. In these embodiments, once the need for a specific function is identified at ANALYZE THE TASK DATA AND DETERMINE THAT THE TASK TO BE PERFORMED IN THE FIRST COMPUTING ENVIRONMENT REQUIRES THE PERFORMANCE OF ONE OR MORE SPECIFIC FUNCTIONS ASSIGNED TO ONE OR MORE TYPES OF HARDENED TASK SPECIFIC VIRTUAL HOSTS OPERATION 307, the appropriate internal task specific logic is provided via virtual host creation data generated in a hardened task specific virtual host creation template. The hardened task specific virtual host is then instantiated at INSTANTIATE AND/OR DEPLOY THE ONE OR MORE TYPES OF HARDENED TASK SPECIFIC VIRTUAL HOSTS ASSIGNED THE REQUIRED ONE OR MORE SPECIFIC FUNCTIONS IN THE FIRST COMPUTING ENVIRONMENT OPERATION 309, in one embodiment, through a hardened task specific virtual host manager.

As noted above, in various embodiments, a hardened task specific virtual host manager is used to instantiate, and/or deploy, the hardened task specific virtual hosts. In one embodiment, the hardened task specific virtual host manager instantiates, and/or deploys, the hardened task specific virtual hosts in accordance with one or more security policies, referred to herein as hardened task specific virtual host deployment policies and/or hardened task specific virtual host deployment policy data.

In various embodiments, the hardened task specific virtual host deployment policy data is open-endedly defined such that the hardened task specific virtual host deployment policy can be defined by the one or more parties such as, but not limited to, the owner of a data center, the owner or provider of a cloud computing environment, the owner or a provider of a service, the owner or provider of one or more resources, and/or any other party. In this way, using the disclosed process for providing a hardened task specific virtual host, the hardened task specific virtual host deployment policy can be tailored to the specific needs of the one or more parties. In addition, hardened task specific virtual host deployment policies can be added, modified, or deleted, as needed to meet the needs of the one or more parties.

In one embodiment, once the one or more hardened task specific virtual hosts capable of performing the identified task required functions identified at ANALYZE THE TASK DATA AND DETERMINE THAT THE TASK TO BE PERFORMED IN THE FIRST COMPUTING ENVIRONMENT REQUIRES THE PERFORMANCE OF ONE OR MORE SPECIFIC FUNCTIONS ASSIGNED TO ONE OR MORE TYPES OF HARDENED TASK SPECIFIC VIRTUAL HOSTS OPERATION 307 are instantiated, and/or deployed, in the first computing environment at INSTANTIATE AND/OR DEPLOY THE ONE OR MORE TYPES OF HARDENED TASK SPECIFIC VIRTUAL HOSTS ASSIGNED THE REQUIRED ONE OR MORE SPECIFIC FUNCTIONS IN THE FIRST COMPUTING ENVIRONMENT OPERATION 309, process flow proceeds to DETERMINE THAT A TYPE OF HARDENED TASK SPECIFIC VIRTUAL HOST HAS PERFORMED THE SPECIFIC FUNCTION ASSIGNED TO THE HARDENED TASK SPECIFIC VIRTUAL HOST IN THE FIRST COMPUTING ENVIRONMENT OPERATION 311.

In various embodiments, the performance of the specific functions assigned to the deployed hardened task specific virtual hosts includes the interaction of the hardened task specific virtual hosts with other virtual assets, and/or resources, in the first computing environment. In various embodiments, these other virtual assets, and/or resources, include, but are not limited to, any virtual assets and/or resources as discussed herein, and/or as known in the art at the time of filing, and/or as developed/made available after the time of filing. In addition, in some embodiments, the resources accessed by the hardened task specific virtual hosts exist in a computing environment other than the first computing environment in which the hardened task specific virtual hosts are deployed.

In one embodiment, at DETERMINE THAT A TYPE OF HARDENED TASK SPECIFIC VIRTUAL HOST HAS PERFORMED THE SPECIFIC FUNCTION ASSIGNED TO THE HARDENED TASK SPECIFIC VIRTUAL HOST IN THE FIRST COMPUTING ENVIRONMENT OPERATION 311 it is determined that a task required function associated with a given hardened task specific virtual host is completed, or that an allotted time for the task required function associated with a given hardened task specific virtual host has expired.

In various embodiments, the hardened task specific virtual hosts are provided with logic allowing them to report back to the hardened task specific virtual host manager when the function assigned to the hardened task specific virtual hosts has been completed.

In other embodiments, the hardened task specific virtual hosts are deployed for a predetermined timeframe considered sufficient to perform the specific function assigned to the hardened task specific virtual host.

In one embodiment, once it is determined that a task required function associated with a given hardened task specific virtual host is completed, or that an allotted time for the task required function associated with a given hardened task specific virtual host has expired, at DETERMINE THAT A TYPE OF HARDENED TASK SPECIFIC VIRTUAL HOST HAS PERFORMED THE SPECIFIC FUNCTION ASSIGNED TO THE HARDENED TASK SPECIFIC VIRTUAL HOST IN THE FIRST COMPUTING ENVIRONMENT OPERATION 311, process flow proceeds to RETIRE THE HARDENED TASK SPECIFIC VIRTUAL HOST DETERMINED TO HAVE PERFORMED THE SPECIFIC FUNCTION ASSIGNED TO THE HARDENED TASK SPECIFIC VIRTUAL HOST OPERATION 313.

In one embodiment, once it is determined that a task required function associated with a given hardened task specific virtual host is completed, or that an allotted time for the task required function associated with a given hardened task specific virtual host has expired, at DETERMINE THAT A TYPE OF HARDENED TASK SPECIFIC VIRTUAL HOST HAS PERFORMED THE SPECIFIC FUNCTION ASSIGNED TO THE HARDENED TASK SPECIFIC VIRTUAL HOST IN THE FIRST COMPUTING ENVIRONMENT OPERATION 311, the given hardened task specific virtual host is retired for later redeployment, or is deleted, at RETIRE THE HARDENED TASK SPECIFIC VIRTUAL HOST DETERMINED TO HAVE PERFORMED THE SPECIFIC FUNCTION ASSIGNED TO THE HARDENED TASK SPECIFIC VIRTUAL HOST OPERATION 313.

As noted above, in this way any potential security risk presented by the continued deployment of a hardened task specific virtual host after the function assigned to that hardened task specific virtual host is completed is removed.

In one embodiment, once it is determined that a task required function associated with a given hardened task specific virtual host is completed, or that an allotted time for the task required function associated with a given hardened task specific virtual host has expired, and the given hardened task specific virtual host is retired for later redeployment, or is deleted, at RETIRE THE HARDENED TASK SPECIFIC VIRTUAL HOST DETERMINED TO HAVE PERFORMED THE SPECIFIC FUNCTION ASSIGNED TO THE HARDENED TASK SPECIFIC VIRTUAL HOST OPERATION 313, process flow proceeds to EXIT OPERATION 330.

In one embodiment, at EXIT OPERATION 330 process 300 for providing and dynamically deploying hardened task specific virtual hosts is exited to await new data.

Using process 300 for providing and dynamically deploying hardened task specific virtual hosts discussed above, different types, or classes, of hardened task specific virtual hosts are instantiated using different types of virtual host creation data provided through the hardened task specific virtual host creation templates. Consequently, by providing different internal task specific logic through the hardened task specific virtual host creation templates, the creator of a hardened task specific virtual host can easily and efficiently instantiate highly specialized hardened task specific virtual hosts to perform specific functions, and then remove or delete the hardened task specific virtual hosts from the first computing environment when the specific functions assigned to the hardened task specific virtual hosts are completed. This provides for an extremely flexible, dynamic, and secure method for providing duty separation, and as many isolated environments as required to perform various tasks, without investing resources in relatively permanent systems as is currently the norm.

Consequently, using process 300 for providing and dynamically deploying hardened task specific virtual hosts, a flexible and dynamic ability to perform various functions is provided in such a way as to minimize the allocation of resources required to perform a given task in a duty separated manner, and/or, in a virtually unlimited number of isolated environments. This provides a level of security and efficiency that is currently unknown.

In one embodiment, each of the one or more types of virtual host creation data is used to instantiate one of one or more types of hardened task specific virtual administrative hosts in a first computing environment. In one embodiment, the virtual host creation data for each type of hardened task specific virtual administrative host includes hardening logic for providing enhanced security and trust for the type of hardened task specific virtual administrative host and internal task specific logic for directing and/or allowing each type of hardened task specific virtual administrative host to perform a different specific administrative function assigned to that type of hardened task specific virtual administrative host.

In one embodiment, when task data indicating an administrative task to be performed in the first computing environment is received, the task data is analyzed to determine if the administrative task to be performed in the first computing environment requires the performance of one or more administrative functions assigned to one or more of the one or more types of hardened task specific virtual administrative hosts. In one embodiment, if it is determined that the administrative task requires the performance of one or more administrative functions assigned to one or more of the one or more types of hardened task specific virtual administrative hosts, the one or more types of hardened task specific virtual administrative hosts assigned the required administrative functions are instantiated and/or deployed in the first computing environment using the virtual host creation data.

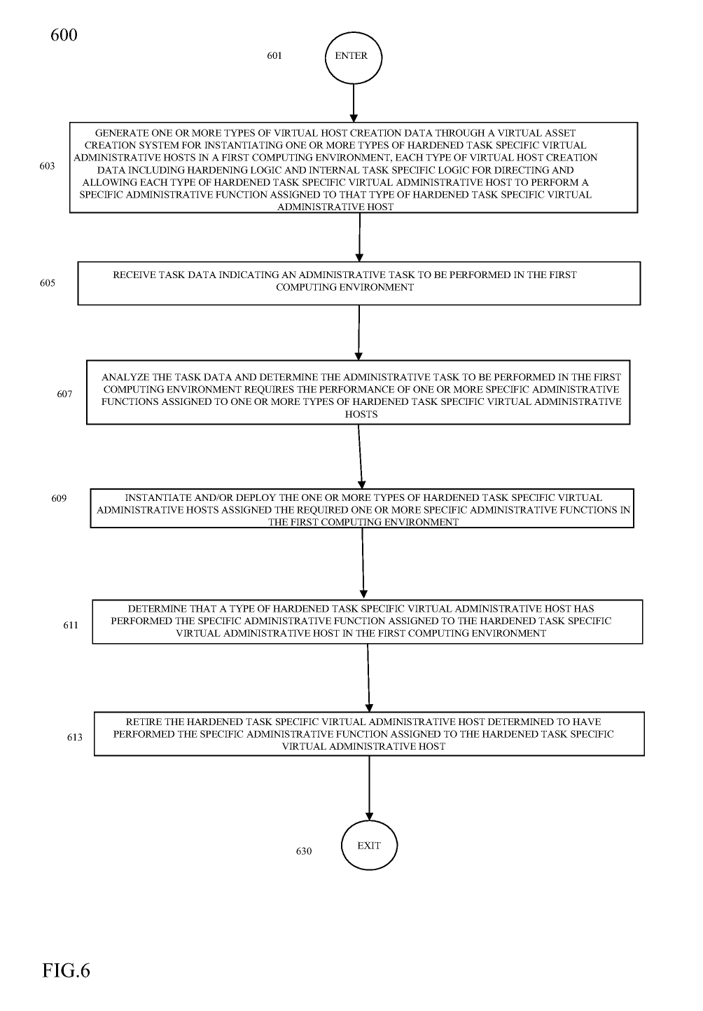

FIG. 6 is a flow chart of a process 600 for providing and dynamically deploying hardened task specific virtual administrative hosts in accordance with one embodiment. In one embodiment, process 600 for providing and dynamically deploying hardened task specific virtual administrative hosts begins at ENTER OPERATION 601 of FIG. 6 and process flow proceeds to GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL ADMINISTRATIVE HOSTS IN A FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL ADMINISTRATIVE HOST TO PERFORM A SPECIFIC ADMINISTRATIVE FUNCTION ASSIGNED TO THAT TYPE OF HARDENED TASK SPECIFIC VIRTUAL ADMINISTRATIVE HOST OPERATION 603.

In one embodiment, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL ADMINISTRATIVE HOSTS IN A FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL ADMINISTRATIVE HOST TO PERFORM A SPECIFIC ADMINISTRATIVE FUNCTION ASSIGNED TO THAT TYPE OF HARDENED TASK SPECIFIC VIRTUAL ADMINISTRATIVE HOST OPERATION 603 one or more hardened task specific virtual administrative hosts are made available in a first computing environment.

In one embodiment, the hardened task specific virtual administrative hosts of GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL ADMINISTRATIVE HOSTS IN A FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL ADMINISTRATIVE HOST TO PERFORM A SPECIFIC ADMINISTRATIVE FUNCTION ASSIGNED TO THAT TYPE OF HARDENED TASK SPECIFIC VIRTUAL ADMINISTRATIVE HOST OPERATION 603 are virtual assets instantiated in the first computing environment. In one embodiment, the hardened task specific virtual administrative hosts are virtual assets instantiated in a cloud computing environment.

In one embodiment, the hardened task specific virtual administrative hosts are instantiated in the first computing environment using a virtual asset creation system such as a virtual asset creation template through which the creator of the hardened task specific virtual administrative host can generate virtual host creation data such as, but not limited to, hardening logic to harden the task specific virtual hosts; internal task specific logic, such as operational logic for directing, and/or allowing, the hardened task specific virtual administrative hosts to perform specific functions assigned to the hardened task specific virtual administrative hosts; and hosted application/process/data assigning resources and attributes to the hardened task specific virtual administrative hosts necessary to perform the specific functions assigned to the hardened task specific virtual administrative hosts.

In one embodiment, by virtue of the customization of the virtual asset templates to instantiate the hardened task specific virtual administrative hosts, the virtual asset templates are transformed into specialized virtual asset templates herein referred to as a hardened task specific virtual administrative host creation templates. In various embodiments, the hardened task specific virtual administrative host creation templates include hardening logic for providing enhanced security and trust in the hardened task specific virtual administrative hosts to be instantiated using the hardened task specific virtual administrative host creation templates, and for identifying the hardened task specific virtual administrative host as a trusted agent generated within the first computing environment.

Numerous means, methods, processes, procedures and systems, are known in the art for providing virtual asset hardening. Consequently, a more detailed description of specific means, methods, processes, procedures, and systems, for hardening task specific virtual hosts to create hardened task specific virtual administrative hosts is omitted here to avoid detracting from the invention.

As noted above, in various embodiments, through the hardened task specific virtual administrative host creation templates, each of the hardened task specific virtual administrative hosts to be instantiated using the hardened task specific virtual administrative host creation templates are provided internal task specific logic, such as operational logic for directing, and/or allowing, the hardened task specific virtual administrative hosts to perform specific functions assigned to the hardened task specific virtual administrative hosts.

As also noted above, hosted application/process/data is provided to each of hardened task specific virtual administrative hosts, as separate logic and/or as part of the internal task specific logic provided to the hardened task specific virtual administrative hosts, assigning resources and attributes to the hardened task specific virtual administrative hosts necessary to perform the specific functions assigned to the hardened task specific virtual administrative hosts.

As discussed above, in various embodiments, different types, or classes, of hardened task specific virtual administrative hosts are instantiated using different types of virtual host creation data provided through the hardened task specific virtual administrative host creation templates. Consequently, by providing different internal task specific logic through the hardened task specific virtual administrative host creation templates, the creator of a hardened task specific virtual administrative host can easily and efficiently instantiate highly specialized hardened task specific virtual administrative hosts to perform specific functions, and, as discussed below, then remove or delete the hardened task specific virtual administrative hosts from the first computing environment when the specific functions assigned to the hardened task specific virtual administrative hosts are completed. This provides for an extremely flexible, dynamic, and secure method for providing duty separation, and as many isolated environments as required to perform various tasks, without investing resources in relatively permanent systems as is currently the norm.

In various embodiments, by simply changing the internal task specific logic provided to a hardened task specific virtual administrative host through a hardened task specific virtual administrative host creation template, the creator of the hardened task specific virtual administrative hosts can create one, or multiple copies of, multiple different types of hardened task specific virtual administrative hosts.

In some embodiments, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL ADMINISTRATIVE HOSTS IN A FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL ADMINISTRATIVE HOST TO PERFORM A SPECIFIC ADMINISTRATIVE FUNCTION ASSIGNED TO THAT TYPE OF HARDENED TASK SPECIFIC VIRTUAL ADMINISTRATIVE HOST OPERATION 603 the different types of hardened task specific virtual administrative hosts are created in advance of an identified need for the specific function assigned to hardened task specific virtual administrative hosts.

In these embodiments, one or more instances of the different types of hardened task specific virtual administrative hosts are then stored to await an identified need for the specific functions assigned to the hardened task specific virtual administrative hosts. In these embodiments, the hardened task specific virtual administrative hosts are then deployed, in one embodiment by a hardened task specific virtual administrative host manager, when the need for the specific function assigned the hardened task specific virtual administrative hosts function is identified. In some embodiments, one or more copies of one or more different types of hardened task specific virtual administrative hosts are grouped together according to a larger task which requires the performance of various task required administrative functions assigned to the one or more instances of the one or more different types of hardened task specific virtual administrative hosts.

In other embodiments, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL ADMINISTRATIVE HOSTS IN A FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL ADMINISTRATIVE HOST TO PERFORM A SPECIFIC ADMINISTRATIVE FUNCTION ASSIGNED TO THAT TYPE OF HARDENED TASK SPECIFIC VIRTUAL ADMINISTRATIVE HOST OPERATION 603 the hardened task specific virtual administrative hosts are instantiated only once the need for a specific function to be assigned to the hardened task specific virtual administrative host is identified. In these embodiments, once the need for a specific function is identified, the appropriate internal task specific logic is provided via virtual host creation data generated in a hardened task specific virtual administrative host creation template. The hardened task specific virtual administrative host is then instantiated, in one embodiment, through a hardened task specific virtual administrative host manager.

Using the hardened task specific virtual administrative hosts described herein, a flexible and dynamic ability to perform various functions is provided in such a way that the allocation of resources required to perform a given task in a duty separated manner, and/or, in a virtually unlimited number of isolated environments, is minimized. This provides a level of security and efficiency that is currently unknown.

As noted above, in one embodiment, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL ADMINISTRATIVE HOSTS IN A FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL ADMINISTRATIVE HOST TO PERFORM A SPECIFIC ADMINISTRATIVE FUNCTION ASSIGNED TO THAT TYPE OF HARDENED TASK SPECIFIC VIRTUAL ADMINISTRATIVE HOST OPERATION 603 one or more copies of one or more types of hardened task specific virtual administrative hosts are instantiated through the generation of one or more types of virtual host creation data using a virtual asset creation system.

As also noted above, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL ADMINISTRATIVE HOSTS IN A FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL ADMINISTRATIVE HOST TO PERFORM A SPECIFIC ADMINISTRATIVE FUNCTION ASSIGNED TO THAT TYPE OF HARDENED TASK SPECIFIC VIRTUAL ADMINISTRATIVE HOST OPERATION 603 part of the virtual host creation data includes hardening logic to establish the hardened task specific virtual administrative hosts as secure and trusted agents in one or more computing environments.

As also noted above, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL ADMINISTRATIVE HOSTS IN A FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL ADMINISTRATIVE HOST TO PERFORM A SPECIFIC ADMINISTRATIVE FUNCTION ASSIGNED TO THAT TYPE OF HARDENED TASK SPECIFIC VIRTUAL ADMINISTRATIVE HOST OPERATION 603 the different types of hardened task specific virtual administrative hosts are created by providing different internal task specific logic to the hardened task specific virtual administrative hosts through hardened task specific virtual administrative host creation templates.

In one embodiment, once one or more hardened task specific virtual administrative hosts are made available for deployment to a first computing environment at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL ADMINISTRATIVE HOSTS IN A FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL ADMINISTRATIVE HOST TO PERFORM A SPECIFIC ADMINISTRATIVE FUNCTION ASSIGNED TO THAT TYPE OF HARDENED TASK SPECIFIC VIRTUAL ADMINISTRATIVE HOST OPERATION 603 process flow proceeds to RECEIVE TASK DATA INDICATING AN ADMINISTRATIVE TASK TO BE PERFORMED IN THE FIRST COMPUTING ENVIRONMENT OPERATION 605.

In one embodiment, at RECEIVE TASK DATA INDICATING AN ADMINISTRATIVE TASK TO BE PERFORMED IN THE FIRST COMPUTING ENVIRONMENT OPERATION 605 task data is received indicating an administrative task to be performed in the first computing environment.

In various embodiments, the task data received at RECEIVE TASK DATA INDICATING AN ADMINISTRATIVE TASK TO BE PERFORMED IN THE FIRST COMPUTING ENVIRONMENT OPERATION 605 represents any one of numerous administrative tasks to be performed in the first computing environment such as, but not limited to, data gathering related tasks, such as forensic analysis related tasks; monitoring related tasks, such as monitoring the operation of various virtual assets and resources associated with a cloud computing environment; maintenance related tasks, such as performing various scheduled and/or on-demand maintenance associated with virtual assets and resources associated with a cloud computing environment; state determination tasks, such as determining the state of a cloud computing environment by obtaining data from various virtual assets and/or resources associated with a cloud computing environment; and/or any other administrative tasks as discussed herein, and/or as known in the art at the time of filing, and/or as developed/becomes known in the art after the time of filing.

In large part due to the almost unlimited types of hardened task specific virtual administrative hosts that can be instantiated and deployed at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL ADMINISTRATIVE HOSTS IN A FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL ADMINISTRATIVE HOST TO PERFORM A SPECIFIC ADMINISTRATIVE FUNCTION ASSIGNED TO THAT TYPE OF HARDENED TASK SPECIFIC VIRTUAL ADMINISTRATIVE HOST OPERATION 603, the types of administrative tasks that can be accomplished using the hardened task specific virtual administrative hosts described herein is virtually unlimited.

In one embodiment, once task data is received indicating an administrative task to be performed in the first computing environment at RECEIVE TASK DATA INDICATING AN ADMINISTRATIVE TASK TO BE PERFORMED IN THE FIRST COMPUTING ENVIRONMENT OPERATION 605, process flow proceeds to ANALYZE THE TASK DATA AND DETERMINE THE ADMINISTRATIVE TASK TO BE PERFORMED IN THE FIRST COMPUTING ENVIRONMENT REQUIRES THE PERFORMANCE OF ONE OR MORE SPECIFIC ADMINISTRATIVE FUNCTIONS ASSIGNED TO ONE OR MORE TYPES OF HARDENED TASK SPECIFIC VIRTUAL ADMINISTRATIVE HOSTS OPERATION 607.

In one embodiment, at ANALYZE THE TASK DATA AND DETERMINE THE ADMINISTRATIVE TASK TO BE PERFORMED IN THE FIRST COMPUTING ENVIRONMENT REQUIRES THE PERFORMANCE OF ONE OR MORE SPECIFIC ADMINISTRATIVE FUNCTIONS ASSIGNED TO ONE OR MORE TYPES OF HARDENED TASK SPECIFIC VIRTUAL ADMINISTRATIVE HOSTS OPERATION 607 the task data of RECEIVE TASK DATA INDICATING AN ADMINISTRATIVE TASK TO BE PERFORMED IN THE FIRST COMPUTING ENVIRONMENT OPERATION 605 is analyzed to determine the task to be performed and what task required administrative functions, or subtasks, need to be accomplished in order to perform the task described in the task data.

In one embodiment, at ANALYZE THE TASK DATA AND DETERMINE THE ADMINISTRATIVE TASK TO BE PERFORMED IN THE FIRST COMPUTING ENVIRONMENT REQUIRES THE PERFORMANCE OF ONE OR MORE SPECIFIC ADMINISTRATIVE FUNCTIONS ASSIGNED TO ONE OR MORE TYPES OF HARDENED TASK SPECIFIC VIRTUAL ADMINISTRATIVE HOSTS OPERATION 607 once the task required administrative functions are identified, one or more hardened task specific virtual administrative hosts of GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL ADMINISTRATIVE HOSTS IN A FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL ADMINISTRATIVE HOST TO PERFORM A SPECIFIC ADMINISTRATIVE FUNCTION ASSIGNED TO THAT TYPE OF HARDENED TASK SPECIFIC VIRTUAL ADMINISTRATIVE HOST OPERATION 603 capable of performing the identified task required administrative functions are also identified.

In one embodiment, once the task data is analyzed to determine the task to be performed and what task required administrative functions, or subtasks, need to be accomplished in order to perform the task described in the task data, and one or more hardened task specific virtual administrative hosts capable of performing the identified task required administrative functions are identified at ANALYZE THE TASK DATA AND DETERMINE THE ADMINISTRATIVE TASK TO BE PERFORMED IN THE FIRST COMPUTING ENVIRONMENT REQUIRES THE PERFORMANCE OF ONE OR MORE SPECIFIC ADMINISTRATIVE FUNCTIONS ASSIGNED TO ONE OR MORE TYPES OF HARDENED TASK SPECIFIC VIRTUAL ADMINISTRATIVE HOSTS OPERATION 607, process flow proceeds to INSTANTIATE AND/OR DEPLOY THE ONE OR MORE TYPES OF HARDENED TASK SPECIFIC VIRTUAL ADMINISTRATIVE HOSTS ASSIGNED THE REQUIRED ONE OR MORE SPECIFIC ADMINISTRATIVE FUNCTIONS IN THE FIRST COMPUTING ENVIRONMENT OPERATION 609.

In one embodiment, at INSTANTIATE AND/OR DEPLOY THE ONE OR MORE TYPES OF HARDENED TASK SPECIFIC VIRTUAL ADMINISTRATIVE HOSTS ASSIGNED THE REQUIRED ONE OR MORE SPECIFIC ADMINISTRATIVE FUNCTIONS IN THE FIRST COMPUTING ENVIRONMENT OPERATION 609 the one or more hardened task specific virtual administrative hosts capable of performing the identified task required administrative functions identified at ANALYZE THE TASK DATA AND DETERMINE THE ADMINISTRATIVE TASK TO BE PERFORMED IN THE FIRST COMPUTING ENVIRONMENT REQUIRES THE PERFORMANCE OF ONE OR MORE SPECIFIC ADMINISTRATIVE FUNCTIONS ASSIGNED TO ONE OR MORE TYPES OF HARDENED TASK SPECIFIC VIRTUAL ADMINISTRATIVE HOSTS OPERATION 607 are instantiated, and/or deployed, in the first computing environment.

As noted above, in some embodiments, the different types of hardened task specific virtual administrative hosts are instantiated at INSTANTIATE AND/OR DEPLOY THE ONE OR MORE TYPES OF HARDENED TASK SPECIFIC VIRTUAL ADMINISTRATIVE HOSTS ASSIGNED THE REQUIRED ONE OR MORE SPECIFIC ADMINISTRATIVE FUNCTIONS IN THE FIRST COMPUTING ENVIRONMENT OPERATION 609 in advance of an identified need for the specific function assigned to hardened task specific virtual administrative hosts at ANALYZE THE TASK DATA AND DETERMINE THE ADMINISTRATIVE TASK TO BE PERFORMED IN THE FIRST COMPUTING ENVIRONMENT REQUIRES THE PERFORMANCE OF ONE OR MORE SPECIFIC ADMINISTRATIVE FUNCTIONS ASSIGNED TO ONE OR MORE TYPES OF HARDENED TASK SPECIFIC VIRTUAL ADMINISTRATIVE HOSTS OPERATION 607.

In these embodiments, one or more instances of the different types of hardened task specific virtual administrative hosts are then stored to await an identified need for the specific functions assigned to the hardened task specific virtual administrative hosts at ANALYZE THE TASK DATA AND DETERMINE THE ADMINISTRATIVE TASK TO BE PERFORMED IN THE FIRST COMPUTING ENVIRONMENT REQUIRES THE PERFORMANCE OF ONE OR MORE SPECIFIC ADMINISTRATIVE FUNCTIONS ASSIGNED TO ONE OR MORE TYPES OF HARDENED TASK SPECIFIC VIRTUAL ADMINISTRATIVE HOSTS OPERATION 607. In these embodiments, the hardened task specific virtual administrative hosts are then deployed at INSTANTIATE AND/OR DEPLOY THE ONE OR MORE TYPES OF HARDENED TASK SPECIFIC VIRTUAL ADMINISTRATIVE HOSTS ASSIGNED THE REQUIRED ONE OR MORE SPECIFIC ADMINISTRATIVE FUNCTIONS IN THE FIRST COMPUTING ENVIRONMENT OPERATION 609, in one embodiment by a hardened task specific virtual administrative host manager, when the need for the specific function assigned the hardened task specific virtual administrative hosts function is identified.

In some embodiments, one or more instances of one or more different types of hardened task specific virtual administrative hosts are grouped together at INSTANTIATE AND/OR DEPLOY THE ONE OR MORE TYPES OF HARDENED TASK SPECIFIC VIRTUAL ADMINISTRATIVE HOSTS ASSIGNED THE REQUIRED ONE OR MORE SPECIFIC ADMINISTRATIVE FUNCTIONS IN THE FIRST COMPUTING ENVIRONMENT OPERATION 609 according to a larger task which requires the performance of various task required administrative functions assigned to the one or more instances of the one or more different types of hardened task specific virtual administrative hosts.

In other embodiments, the hardened task specific virtual administrative hosts are instantiated at INSTANTIATE AND/OR DEPLOY THE ONE OR MORE TYPES OF HARDENED TASK SPECIFIC VIRTUAL ADMINISTRATIVE HOSTS ASSIGNED THE REQUIRED ONE OR MORE SPECIFIC ADMINISTRATIVE FUNCTIONS IN THE FIRST COMPUTING ENVIRONMENT OPERATION 609 only once the need for a specific function to be assigned to the hardened task specific virtual administrative host is identified at ANALYZE THE TASK DATA AND DETERMINE THE ADMINISTRATIVE TASK TO BE PERFORMED IN THE FIRST COMPUTING ENVIRONMENT REQUIRES THE PERFORMANCE OF ONE OR MORE SPECIFIC ADMINISTRATIVE FUNCTIONS ASSIGNED TO ONE OR MORE TYPES OF HARDENED TASK SPECIFIC VIRTUAL ADMINISTRATIVE HOSTS OPERATION 607. In these embodiments, once the need for a specific function is identified at ANALYZE THE TASK DATA AND DETERMINE THE ADMINISTRATIVE TASK TO BE PERFORMED IN THE FIRST COMPUTING ENVIRONMENT REQUIRES THE PERFORMANCE OF ONE OR MORE SPECIFIC ADMINISTRATIVE FUNCTIONS ASSIGNED TO ONE OR MORE TYPES OF HARDENED TASK SPECIFIC VIRTUAL ADMINISTRATIVE HOSTS OPERATION 607, the appropriate internal task specific logic is provided via virtual host creation data generated in a hardened task specific virtual administrative host creation template. The hardened task specific virtual administrative host is then instantiated at INSTANTIATE AND/OR DEPLOY THE ONE OR MORE TYPES OF HARDENED TASK SPECIFIC VIRTUAL ADMINISTRATIVE HOSTS ASSIGNED THE REQUIRED ONE OR MORE SPECIFIC ADMINISTRATIVE FUNCTIONS IN THE FIRST COMPUTING ENVIRONMENT OPERATION 609, in one embodiment, through a hardened task specific virtual administrative host manager.

As noted above, in various embodiments, a hardened task specific virtual administrative host manager is used to instantiate, and/or deploy, the hardened task specific virtual administrative hosts. In one embodiment, the hardened task specific virtual administrative host manager instantiates, and/or deploys, the hardened task specific virtual administrative hosts in accordance with one or more security policies, referred to herein as hardened task specific virtual administrative host deployment policies and/or hardened task specific virtual administrative host deployment policy data.

In various embodiments, the hardened task specific virtual administrative host deployment policy data is open-endedly defined such that the hardened task specific virtual administrative host deployment policy can be defined by the one or more parties such as, but not limited to, the owner of a data center, the owner or provider of a cloud computing environment, the owner or a provider of a service, the owner or provider of one or more resources, and/or any other party. In this way, using the disclosed process for providing a hardened task specific virtual administrative host, the hardened task specific virtual administrative host deployment policy can be tailored to the specific needs of the one or more parties. In addition, hardened task specific virtual administrative host deployment policies can be added, modified, or deleted, as needed to meet the needs of the one or more parties.

In one embodiment, once the one or more hardened task specific virtual administrative hosts capable of performing the identified task required administrative functions identified at ANALYZE THE TASK DATA AND DETERMINE THE ADMINISTRATIVE TASK TO BE PERFORMED IN THE FIRST COMPUTING ENVIRONMENT REQUIRES THE PERFORMANCE OF ONE OR MORE SPECIFIC ADMINISTRATIVE FUNCTIONS ASSIGNED TO ONE OR MORE TYPES OF HARDENED TASK SPECIFIC VIRTUAL ADMINISTRATIVE HOSTS OPERATION 607 are instantiated, and/or deployed, in the first computing environment at INSTANTIATE AND/OR DEPLOY THE ONE OR MORE TYPES OF HARDENED TASK SPECIFIC VIRTUAL ADMINISTRATIVE HOSTS ASSIGNED THE REQUIRED ONE OR MORE SPECIFIC ADMINISTRATIVE FUNCTIONS IN THE FIRST COMPUTING ENVIRONMENT OPERATION 609, process flow proceeds to DETERMINE THAT A TYPE OF HARDENED TASK SPECIFIC VIRTUAL ADMINISTRATIVE HOST HAS PERFORMED THE SPECIFIC ADMINISTRATIVE FUNCTION ASSIGNED TO THE HARDENED TASK SPECIFIC VIRTUAL ADMINISTRATIVE HOST IN THE FIRST COMPUTING ENVIRONMENT OPERATION 611.

In various embodiments, the performance of the specific functions assigned to the deployed hardened task specific virtual administrative hosts includes the interaction of the hardened task specific virtual administrative hosts with other virtual assets, and/or resources, in the first computing environment. In various embodiments, these other virtual assets, and/or resources, include, but are not limited to, any virtual assets and/or resources as discussed herein, and/or as known in the art at the time of filing, and/or as developed/made available after the time of filing. In addition, in some embodiments, the resources accessed by the hardened task specific virtual administrative hosts exist in a computing environment other than the first computing environment in which the hardened task specific virtual administrative hosts are deployed.

In one embodiment, at DETERMINE THAT A TYPE OF HARDENED TASK SPECIFIC VIRTUAL ADMINISTRATIVE HOST HAS PERFORMED THE SPECIFIC ADMINISTRATIVE FUNCTION ASSIGNED TO THE HARDENED TASK SPECIFIC VIRTUAL ADMINISTRATIVE HOST IN THE FIRST COMPUTING ENVIRONMENT OPERATION 611 it is determined that an administrative task required function associated with a given hardened task specific virtual administrative host is completed, or that an allotted time for the task required function associated with a given hardened task specific virtual administrative host has expired.

In various embodiments, the hardened task specific virtual administrative hosts are provided with logic allowing them to report back to the hardened task specific virtual administrative host manager when the function assigned to the hardened task specific virtual administrative hosts has been completed.

In other embodiments, the hardened task specific virtual administrative hosts are deployed for a predetermined timeframe considered sufficient to perform the specific function assigned to the hardened task specific virtual administrative host.

In one embodiment, once it is determined that an administrative task required function associated with a given hardened task specific virtual administrative host is completed, or that an allotted time for the task required function associated with a given hardened task specific virtual administrative host has expired at DETERMINE THAT A TYPE OF HARDENED TASK SPECIFIC VIRTUAL ADMINISTRATIVE HOST HAS PERFORMED THE SPECIFIC ADMINISTRATIVE FUNCTION ASSIGNED TO THE HARDENED TASK SPECIFIC VIRTUAL ADMINISTRATIVE HOST IN THE FIRST COMPUTING ENVIRONMENT OPERATION 611, process flow proceeds to RETIRE THE HARDENED TASK SPECIFIC VIRTUAL ADMINISTRATIVE HOST DETERMINED TO HAVE PERFORMED THE SPECIFIC ADMINISTRATIVE FUNCTION ASSIGNED TO THE HARDENED TASK SPECIFIC VIRTUAL ADMINISTRATIVE HOST OPERATION 613.

In one embodiment, once it is determined that an administrative task required function associated with a given hardened task specific virtual administrative host is completed, or that an allotted time for the task required function associated with a given hardened task specific virtual administrative host has expired, at DETERMINE THAT A TYPE OF HARDENED TASK SPECIFIC VIRTUAL ADMINISTRATIVE HOST HAS PERFORMED THE SPECIFIC ADMINISTRATIVE FUNCTION ASSIGNED TO THE HARDENED TASK SPECIFIC VIRTUAL ADMINISTRATIVE HOST IN THE FIRST COMPUTING ENVIRONMENT OPERATION 611, the given hardened task specific virtual administrative host is retired for later redeployment, or is deleted, at RETIRE THE HARDENED TASK SPECIFIC VIRTUAL ADMINISTRATIVE HOST DETERMINED TO HAVE PERFORMED THE SPECIFIC ADMINISTRATIVE FUNCTION ASSIGNED TO THE HARDENED TASK SPECIFIC VIRTUAL ADMINISTRATIVE HOST OPERATION 613.

As noted above, in this way any potential security risk presented by the continued deployment of a hardened task specific virtual administrative host after the function assigned to that hardened task specific virtual administrative host is completed is removed.

In one embodiment, once it is determined that an administrative task required function associated with a given hardened task specific virtual administrative host is completed, or that an allotted time for the task required function associated with a given hardened task specific virtual administrative host has expired, and the given hardened task specific virtual administrative host is retired for later redeployment, or is deleted, at RETIRE THE HARDENED TASK SPECIFIC VIRTUAL ADMINISTRATIVE HOST DETERMINED TO HAVE PERFORMED THE SPECIFIC ADMINISTRATIVE FUNCTION ASSIGNED TO THE HARDENED TASK SPECIFIC VIRTUAL ADMINISTRATIVE HOST OPERATION 613, process flow proceeds to EXIT OPERATION 630.

In one embodiment, at EXIT OPERATION 630 process 600 for providing and dynamically deploying hardened task specific virtual administrative hosts is exited to await new data.

Using process 600 for providing and dynamically deploying hardened task specific virtual administrative hosts discussed above, different types, or classes, of hardened task specific virtual administrative hosts are instantiated using different types of virtual host creation data provided through the hardened task specific virtual administrative host creation templates. Consequently, by providing different internal task specific logic through the hardened task specific virtual administrative host creation templates, the creator of a hardened task specific virtual administrative host can easily and efficiently instantiate highly specialized hardened task specific virtual administrative hosts to perform specific functions, and then remove or delete the hardened task specific virtual administrative hosts from the first computing environment when the specific functions assigned to the hardened task specific virtual administrative hosts are completed. This provides for an extremely flexible, dynamic, and secure method for providing duty separation, and as many isolated environments as required to perform various tasks, without investing resources in relatively permanent systems as is currently the norm.

Consequently, using process 600 for providing and dynamically deploying hardened task specific virtual administrative hosts, a flexible and dynamic ability to perform various functions is provided in such a way as to minimize the allocation of resources required to perform a given task in a duty separated manner, and/or, in a virtually unlimited number of isolated environments. This provides a level of security and efficiency that is currently unknown.

In one embodiment one or more types of virtual host creation data is generated through a virtual asset creation system, each of the one or more types of virtual host creation data for instantiating one of one or more types of hardened task specific virtual bastion hosts in the first computing environment, the virtual host creation data for each type of hardened task specific virtual bastion host including hardening logic for providing enhanced security and trust for the type of hardened task specific virtual bastion host and internal task specific logic for directing and/or allowing each type of hardened task specific virtual bastion host to perform a different specific function associated with the request data and assigned to that type of hardened task specific virtual bastion host.

In accordance with one embodiment, request data is received from a requesting virtual asset in a first computing environment, the request data requesting access to one more assets. In one embodiment, the requesting virtual asset is then authenticated.

In one embodiment, the one or more types of hardened task specific virtual bastion hosts assigned specific functions associated with the request data are instantiated and deployed in the first computing environment using the virtual host creation data and the requesting virtual asset is provided access to the one or more types of hardened task specific virtual bastion hosts assigned the specific function associated with the request data.

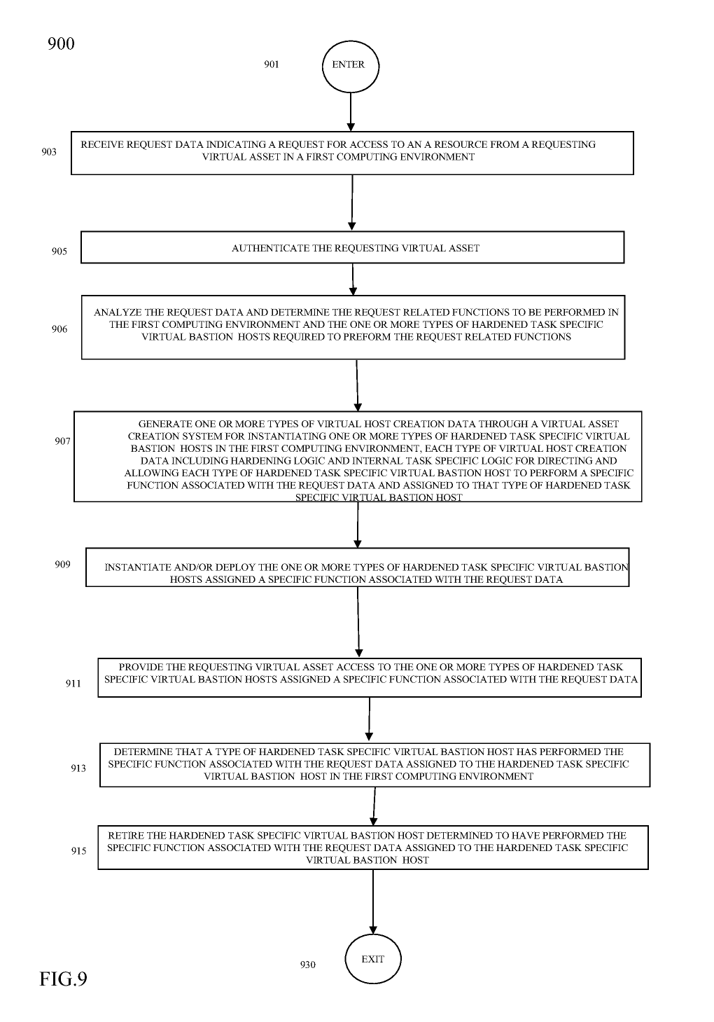

FIG. 9 is a flow chart of a process 900 for providing and dynamically deploying hardened task specific virtual bastion hosts in accordance with one embodiment. In one embodiment, process 900 for providing and dynamically deploying hardened task specific virtual bastion hosts begins at ENTER OPERATION 901 of FIG. 9 and process flow proceeds to RECEIVE REQUEST DATA INDICATING A REQUEST FOR ACCESS TO A RESOURCE FROM A REQUESTING VIRTUAL ASSET IN A FIRST COMPUTING ENVIRONMENT OPERATION 903.

In one embodiment, at RECEIVE REQUEST DATA INDICATING A REQUEST FOR ACCESS TO A RESOURCE FROM A REQUESTING VIRTUAL ASSET IN A FIRST COMPUTING ENVIRONMENT OPERATION 903 request data is received indicating a request for access to one or more resources and/or assets from a requesting virtual asset, or other requesting asset, in the first computing environment.

In various embodiments, the request data includes data requesting access to one or more resources and/or assets from one or more requesting virtual assets, and/or other requesting resources, and/or requesting assets, implemented in, and/or associated with, a first computing environment, such as a cloud computing environment. In one embodiment, these requesting virtual assets, and/or requesting resources, include, but are not limited to, any virtual assets and/or resources as discussed herein, and/or as known in the art at the time of filing, and/or as developed/made available after the time of filing. In addition, in some embodiments, the resources for which access is being requested exist in a computing environment other than the first computing environment in which requesting virtual assets, and/or other requesting resources, reside.

In one embodiment, once request data is received indicating a request for access to one or more resources from a requesting virtual asset, or other requesting asset or resource, in the first computing environment at RECEIVE REQUEST DATA INDICATING A REQUEST FOR ACCESS TO A RESOURCE FROM A REQUESTING VIRTUAL ASSET IN A FIRST COMPUTING ENVIRONMENT OPERATION 903, process flow proceeds to AUTHENTICATE THE REQUESTING VIRTUAL ASSET OPERATION 905.

In one embodiment, at AUTHENTICATE THE REQUESTING VIRTUAL ASSET OPERATION 905 the requesting virtual assets, and/or other requesting assets and requesting resources, requesting access to other resources and/or data are authenticated. In one embodiment the requesting virtual assets, and/or other requesting assets and requesting resources, are authenticated using an access management system.

In one embodiment, once request data is received indicating a request for access to one or more resources from a requesting virtual asset, or other requesting asset, in the first computing environment and the requesting virtual assets, and/or other requesting assets and requesting resources, requesting access to other resources and/or data are authenticated at AUTHENTICATE THE REQUESTING VIRTUAL ASSET OPERATION 905, process flow proceeds to ANALYZE THE REQUEST DATA AND DETERMINE THE REQUEST RELATED FUNCTIONS TO BE PERFORMED IN THE FIRST COMPUTING ENVIRONMENT AND THE ONE OR MORE TYPES OF HARDENED TASK SPECIFIC VIRTUAL BASTION HOSTS REQUIRED TO PREFORM THE REQUEST RELATED FUNCTIONS 906.

In one embodiment, at ANALYZE THE REQUEST DATA AND DETERMINE THE REQUEST RELATED FUNCTIONS TO BE PERFORMED IN THE FIRST COMPUTING ENVIRONMENT AND THE ONE OR MORE TYPES OF HARDENED TASK SPECIFIC VIRTUAL BASTION HOSTS REQUIRED TO PREFORM THE REQUEST RELATED FUNCTIONS 906 the request data of RECEIVE REQUEST DATA INDICATING A REQUEST FOR ACCESS TO A RESOURCE FROM A REQUESTING VIRTUAL ASSET IN A FIRST COMPUTING ENVIRONMENT OPERATION 903 is analyzed to determine the access being requested and what request related functions, or tasks, are needed to provide the requested access in accordance with the one or more data and resource access policies.

In one embodiment, at ANALYZE THE REQUEST DATA AND DETERMINE THE REQUEST RELATED FUNCTIONS TO BE PERFORMED IN THE FIRST COMPUTING ENVIRONMENT AND THE ONE OR MORE TYPES OF HARDENED TASK SPECIFIC VIRTUAL BASTION HOSTS REQUIRED TO PREFORM THE REQUEST RELATED FUNCTIONS 906 the one or more hardened task specific virtual bastion hosts capable of performing the identified request related functions are identified.

In one embodiment, once the request data is analyzed to determine the access being requested and what request related functions, or tasks, are needed to provide the requested access in accordance with the one or more data and resource access policies, and the one or more hardened task specific virtual bastion hosts capable of performing the identified request related functions are identified at ANALYZE THE REQUEST DATA AND DETERMINE THE REQUEST RELATED FUNCTIONS TO BE PERFORMED IN THE FIRST COMPUTING ENVIRONMENT AND THE ONE OR MORE TYPES OF HARDENED TASK SPECIFIC VIRTUAL BASTION HOSTS REQUIRED TO PREFORM THE REQUEST RELATED FUNCTIONS 906, process flow proceeds to GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL BASTION HOSTS IN THE FIRST COMPUTING ENVIRONMENT, EACH TYPE OF VIRTUAL HOST CREATION DATA INCLUDING HARDENING LOGIC AND INTERNAL TASK SPECIFIC LOGIC FOR DIRECTING AND ALLOWING EACH TYPE OF HARDENED TASK SPECIFIC VIRTUAL BASTION HOST TO PERFORM A SPECIFIC FUNCTION ASSOCIATED WITH THE REQUEST DATA AND ASSIGNED TO THAT TYPE OF HARDENED TASK SPECIFIC VIRTUAL BASTION HOST OPERATION 907.

In one embodiment, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL BASTION HOSTS IN THE FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL BASTION HOST TO PERFORM A SPECIFIC FUNCTION ASSOCIATED WITH THE REQUEST DATA AND ASSIGNED TO THAT TYPE OF HARDENED TASK SPECIFIC VIRTUAL BASTION HOST OPERATION 907 the one or more hardened task specific virtual bastion hosts capable of performing the identified request related functions are made available in the first computing environment.

In one embodiment, the hardened task specific virtual bastion hosts of GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL BASTION HOSTS IN THE FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL BASTION HOST TO PERFORM A SPECIFIC FUNCTION ASSOCIATED WITH THE REQUEST DATA AND ASSIGNED TO THAT TYPE OF HARDENED TASK SPECIFIC VIRTUAL BASTION HOST OPERATION 907 are virtual assets instantiated in the first computing environment. In one embodiment, the hardened task specific virtual bastion hosts are virtual assets instantiated in a cloud computing environment.

In one embodiment, the hardened task specific virtual bastion hosts are instantiated in the first computing environment using a virtual asset creation system such as a virtual asset creation template through which the creator of the hardened task specific virtual bastion host can generate virtual host creation data such as, but not limited to, hardening logic to harden the task specific virtual bastion hosts; internal task specific logic, such as operational logic for directing, and/or allowing, the hardened task specific virtual bastion hosts to perform specific functions assigned to the hardened task specific virtual bastion hosts; and hosted application/process/data assigning resources and attributes to the hardened task specific virtual bastion hosts necessary to perform the specific functions assigned to the hardened task specific virtual bastion hosts.

Numerous means, methods, processes, procedures and systems, are known in the art for providing virtual asset hardening. Consequently, a more detailed description of specific means, methods, processes, procedures, and systems, for hardening task specific virtual bastion hosts to create hardened task specific virtual bastion hosts is omitted here to avoid detracting from the invention.

As noted above, in various embodiments, through the hardened task specific virtual bastion host creation templates, each of the hardened task specific virtual bastion hosts to be instantiated using the hardened task specific virtual bastion host creation templates are provided internal task specific logic, such as operational logic for directing, and/or allowing, the hardened task specific virtual bastion hosts to perform specific functions assigned to the hardened task specific virtual bastion hosts.

As also noted above, hosted application/process/data is provided to each of hardened task specific virtual bastion hosts, as separate logic and/or as part of the internal task specific logic provided to the hardened task specific virtual bastion hosts, assigning resources and attributes to the hardened task specific virtual bastion hosts necessary to perform the specific functions assigned to the hardened task specific virtual bastion hosts.

As discussed above, in various embodiments, different types, or classes, of hardened task specific virtual bastion hosts are instantiated using different types of virtual host creation data provided through the hardened task specific virtual bastion host creation templates. Consequently, by providing different internal task specific logic through the hardened task specific virtual bastion host creation templates, the creator of a hardened task specific virtual bastion host can easily and efficiently instantiate highly specialized hardened task specific virtual bastion hosts to perform specific functions, and, as discussed below, then remove or delete the hardened task specific virtual bastion hosts from the first computing environment when the specific functions assigned to the hardened task specific virtual bastion hosts are completed. This provides for an extremely flexible, dynamic, and secure method for providing duty separation, and as many isolated environments as required to perform various tasks, without investing resources in relatively permanent systems as is currently the norm.

In various embodiments, by simply changing the internal task specific logic provided to a hardened task specific virtual bastion host through a hardened task specific virtual bastion host creation template, the creator of the hardened task specific virtual bastion hosts can create one, or multiple copies of, multiple different types of hardened task specific virtual bastion hosts.

In some embodiments, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL BASTION HOSTS IN THE FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL BASTION HOST TO PERFORM A SPECIFIC FUNCTION ASSOCIATED WITH THE REQUEST DATA AND ASSIGNED TO THAT TYPE OF HARDENED TASK SPECIFIC VIRTUAL BASTION HOST OPERATION 907 the different types of hardened task specific virtual bastion hosts are created in advance of an identified need for the specific function assigned to hardened task specific virtual bastion hosts.

In these embodiments, one or more copies of the different types of hardened task specific virtual bastion hosts are then stored to await an identified need for the specific functions assigned to the hardened task specific virtual bastion hosts. In these embodiments, the hardened task specific virtual bastion hosts are then deployed, in one embodiment by a hardened task specific virtual bastion host manager, when the need for the specific function assigned the hardened task specific virtual bastion hosts function is identified.

In some embodiments, one or more instances of one or more different types of hardened task specific virtual bastion hosts are grouped together according to a larger task/request which requires the performance of various request/task required functions assigned to the one or more copies of the one or more different types of hardened task specific virtual bastion hosts.

In other embodiments, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL BASTION HOSTS IN THE FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL BASTION HOST TO PERFORM A SPECIFIC FUNCTION ASSOCIATED WITH THE REQUEST DATA AND ASSIGNED TO THAT TYPE OF HARDENED TASK SPECIFIC VIRTUAL BASTION HOST OPERATION 907 the hardened task specific virtual bastion hosts are instantiated only once the need for a specific function to be assigned to the hardened task specific virtual bastion host is identified. In these embodiments, once the need for a specific function is identified, the appropriate internal task specific logic is provided via virtual host creation data generated in a hardened task specific virtual bastion host creation template. The hardened task specific virtual bastion host is then instantiated, in one embodiment, through a hardened task specific virtual bastion host manager.

Using the hardened task specific virtual bastion hosts described herein, a flexible and dynamic ability to perform various functions is provided in such a way that the allocation of resources required to perform a given task in a duty separated manner, and/or, in a virtually unlimited number of isolated environments, is minimized. This provides a level of security and efficiency that is currently unknown.

As noted above, in one embodiment, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL BASTION HOSTS IN THE FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL BASTION HOST TO PERFORM A SPECIFIC FUNCTION ASSOCIATED WITH THE REQUEST DATA AND ASSIGNED TO THAT TYPE OF HARDENED TASK SPECIFIC VIRTUAL BASTION HOST OPERATION 907 one or more instances of one or more types of hardened task specific virtual bastion hosts are instantiated through the generation of one or more types of virtual host creation data using a virtual asset creation system.

As also noted above, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL BASTION HOSTS IN THE FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL BASTION HOST TO PERFORM A SPECIFIC FUNCTION ASSOCIATED WITH THE REQUEST DATA AND ASSIGNED TO THAT TYPE OF HARDENED TASK SPECIFIC VIRTUAL BASTION HOST OPERATION 907 part of the virtual host creation data includes hardening logic to establish the hardened task specific virtual bastion hosts as secure and trusted agents in one or more computing environments.

As also noted above, at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL BASTION HOSTS IN THE FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL BASTION HOST TO PERFORM A SPECIFIC FUNCTION ASSOCIATED WITH THE REQUEST DATA AND ASSIGNED TO THAT TYPE OF HARDENED TASK SPECIFIC VIRTUAL BASTION HOST OPERATION 907 the different types of hardened task specific virtual bastion hosts are created by providing different internal task specific logic to the hardened task specific virtual bastion hosts through hardened task specific virtual bastion host creation templates.

In one embodiment, the hardened task specific virtual hosts are specialized hardened task specific virtual bastion hosts used to perform data and resource access related functions such as, but not limited to, providing isolated sub-environments; providing gating and data access restriction functions; providing hardened caching functions; and various other functions typically associated with request data received from one of more other, requesting, virtual assets in a computing environment, requesting access to data and/or one or more resources, as discussed herein, and/or as known in the art at the time of filing, and/or as developed/becomes known in the art after the time of filing.

In one embodiment, once the one or more hardened task specific virtual bastion hosts capable of performing the identified request related functions are made available in the first computing environment at GENERATE ONE OR MORE TYPES OF VIRTUAL HOST CREATION DATA THROUGH A VIRTUAL ASSET CREATION SYSTEM FOR INSTANTIATING ONE OR MORE TYPES OF HARDENED TASK SPECIFIC VIRTUAL BASTION HOSTS IN THE FIRST COMPUTING ENVIRONMENT, EACH TYPE OF VIRTUAL HOST CREATION DATA INCLUDING SECURITY LOGIC AND INTERNAL TASK SPECIFIC LOGIC FOR DIRECTING AND ALLOWING EACH TYPE OF HARDENED TASK SPECIFIC VIRTUAL BASTION HOST TO PERFORM A SPECIFIC FUNCTION ASSOCIATED WITH THE REQUEST DATA AND ASSIGNED TO THAT TYPE OF HARDENED TASK SPECIFIC VIRTUAL BASTION HOST OPERATION 907, process flow proceeds to INSTANTIATE AND/OR DEPLOY THE ONE OR MORE TYPES OF HARDENED TASK SPECIFIC VIRTUAL BASTION HOSTS ASSIGNED A SPECIFIC FUNCTION ASSOCIATED WITH THE REQUEST DATA OPERATION 909.

In one embodiment, at INSTANTIATE AND/OR DEPLOY THE ONE OR MORE TYPES OF HARDENED TASK SPECIFIC VIRTUAL BASTION HOSTS ASSIGNED A SPECIFIC FUNCTION ASSOCIATED WITH THE REQUEST DATA OPERATION 909 the one or more hardened task specific virtual bastion hosts capable of performing the identified request related functions are instantiated and/or deployed in the first computing environment.

In one embodiment, once the one or more hardened task specific virtual bastion hosts capable of performing the identified request related functions are instantiated and/or deployed in the first computing environment at INSTANTIATE AND/OR DEPLOY THE ONE OR MORE TYPES OF HARDENED TASK SPECIFIC VIRTUAL BASTION HOSTS ASSIGNED A SPECIFIC FUNCTION ASSOCIATED WITH THE REQUEST DATA OPERATION 909, process flow proceeds to PROVIDE THE REQUESTING VIRTUAL ASSET ACCESS TO THE ONE OR MORE TYPES OF HARDENED TASK SPECIFIC VIRTUAL BASTION HOSTS ASSIGNED A SPECIFIC FUNCTION ASSOCIATED WITH THE REQUEST DATA OPERATION 911.

In one embodiment, at PROVIDE THE REQUESTING VIRTUAL ASSET ACCESS TO THE ONE OR MORE TYPES OF HARDENED TASK SPECIFIC VIRTUAL BASTION HOSTS ASSIGNED A SPECIFIC FUNCTION ASSOCIATED WITH THE REQUEST DATA OPERATION 911 the requesting virtual asset, and/or other requesting asset or requesting resource, of RECEIVE REQUEST DATA INDICATING A REQUEST FOR ACCESS TO A RESOURCE FROM A REQUESTING VIRTUAL ASSET IN A FIRST COMPUTING ENVIRONMENT OPERATION 903 is provided access to the requested data and/or other resource using the one or more hardened task specific virtual bastion hosts capable of performing the identified request related functions instantiated and/or deployed in the first computing environment of INSTANTIATE AND/OR DEPLOY THE ONE OR MORE TYPES OF HARDENED TASK SPECIFIC VIRTUAL BASTION HOSTS ASSIGNED A SPECIFIC FUNCTION ASSOCIATED WITH THE REQUEST DATA OPERATION 909.

In one embodiment, once the requesting virtual asset, and/or other requesting asset or requesting resource, is provided access to the requested data and/or other resource using the one or more hardened task specific virtual bastion hosts capable of performing the identified request related functions instantiated and/or deployed in the first computing environment at PROVIDE THE REQUESTING VIRTUAL ASSET ACCESS TO THE ONE OR MORE TYPES OF HARDENED TASK SPECIFIC VIRTUAL BASTION HOSTS ASSIGNED A SPECIFIC FUNCTION ASSOCIATED WITH THE REQUEST DATA OPERATION 911, process flow proceeds to DETERMINE THAT A TYPE OF HARDENED TASK SPECIFIC VIRTUAL BASTION HOST HAS PERFORMED THE SPECIFIC FUNCTION ASSOCIATED WITH THE REQUEST DATA ASSIGNED TO THE HARDENED TASK SPECIFIC VIRTUAL BASTION HOST IN THE FIRST COMPUTING ENVIRONMENT OPERATION 913.

In one embodiment, at DETERMINE THAT A TYPE OF HARDENED TASK SPECIFIC VIRTUAL BASTION HOST HAS PERFORMED THE SPECIFIC FUNCTION ASSOCIATED WITH THE REQUEST DATA ASSIGNED TO THE HARDENED TASK SPECIFIC VIRTUAL BASTION HOST IN THE FIRST COMPUTING ENVIRONMENT OPERATION 913 it is determined that request related function associated with a given hardened task specific virtual bastion host is completed, or that an allotted time for the request related function associated with a given hardened task specific virtual bastion host has expired.

In one embodiment, once it is determined that request related function associated with a given hardened task specific virtual bastion host is completed, or that an allotted time for the request related function associated with a given hardened task specific virtual bastion host has expired, at DETERMINE THAT A TYPE OF HARDENED TASK SPECIFIC VIRTUAL BASTION HOST HAS PERFORMED THE SPECIFIC FUNCTION ASSOCIATED WITH THE REQUEST DATA ASSIGNED TO THE HARDENED TASK SPECIFIC VIRTUAL BASTION HOST IN THE FIRST COMPUTING ENVIRONMENT OPERATION 913, process flow proceeds to RETIRE THE HARDENED TASK SPECIFIC VIRTUAL BASTION HOST DETERMINED TO HAVE PERFORMED THE SPECIFIC FUNCTION ASSOCIATED WITH THE REQUEST DATA ASSIGNED TO THE HARDENED TASK SPECIFIC VIRTUAL BASTION HOST OPERATION 915.

In one embodiment, at RETIRE THE HARDENED TASK SPECIFIC VIRTUAL BASTION HOST DETERMINED TO HAVE PERFORMED THE SPECIFIC FUNCTION ASSOCIATED WITH THE REQUEST DATA ASSIGNED TO THE HARDENED TASK SPECIFIC VIRTUAL BASTION HOST OPERATION 915 once the request related function associated with a given hardened task specific virtual bastion host is completed, the given hardened task specific virtual bastion host is retired for later redeployment, or is deleted.

As noted above, in this way, any potential security risk presented by the continued deployment of a hardened task specific virtual bastion host after the function assigned to that hardened task specific virtual bastion host is completed is removed.

In one embodiment, once the request related function associated with a given hardened task specific virtual bastion host is completed, and the given hardened task specific virtual bastion host is retired for later redeployment, or is deleted, at RETIRE THE HARDENED TASK SPECIFIC VIRTUAL BASTION HOST DETERMINED TO HAVE PERFORMED THE SPECIFIC FUNCTION ASSOCIATED WITH THE REQUEST DATA ASSIGNED TO THE HARDENED TASK SPECIFIC VIRTUAL BASTION HOST OPERATION 915, process flow proceeds to EXIT OPERATION 930.

In one embodiment, at EXIT OPERATION 930 process 900 for providing and dynamically deploying hardened task specific virtual bastion hosts is exited to await new data.

Using process 900 for providing and dynamically deploying hardened task specific virtual bastion hosts, different types, or classes, of hardened task specific virtual bastion hosts are instantiated using different types of virtual host creation data provided through the hardened task specific virtual bastion host creation templates. Consequently, by providing different internal task specific logic through the hardened task specific virtual bastion host creation templates, the creator of a hardened task specific virtual bastion host can easily and efficiently instantiate highly specialized hardened task specific virtual bastion hosts to perform specific functions in an isolated environment, and then remove or delete the hardened task specific virtual bastion hosts from the first computing environment when the specific functions assigned to the hardened task specific virtual bastion hosts are completed. This provides for an extremely flexible, dynamic, and secure method for providing duty separation, and as many isolated environments as required to perform various tasks, without investing resources in relatively permanent systems as is currently the norm.

Consequently, using process 900 for providing and dynamically deploying hardened task specific virtual bastion hosts, a flexible and dynamic ability to perform various functions is provided in such a way as to minimize the allocation of resources required to perform a given task in a duty separated manner, and/or, in a virtually unlimited number of isolated environments. This provides a level of security and efficiency that is currently unknown.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGS., or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A system for providing and dynamically deploying hardened task specific virtual hosts comprising:
at least one processor; and
at least one memory coupled to the at least one processor, the at least one memory having stored therein instructions which when executed by any set of the one or more processors, perform a process for providing and dynamically deploying hardened task specific virtual hosts, the process for providing and dynamically deploying hardened task specific virtual hosts including:
generating virtual host creation data through a virtual asset creation system, the virtual host creation data for instantiating a hardened task specific virtual host in a first computing environment, the virtual host creation data including:
hardening logic for providing enhanced security and trust for the hardened task specific virtual host; and
internal task specific logic for directing and/or allowing the hardened task specific virtual host to perform a specific function assigned to the hardened task specific virtual host;
receiving task data indicating a task to be performed in the first computing environment;
determining the task to be performed in the first computing environment requires the performance of the specific function assigned to the hardened task specific virtual host; and
instantiating and deploying the hardened task specific virtual host in the first computing environment using the virtual host creation data.

2. The system for providing and dynamically deploying hardened task specific virtual hosts of claim 1 wherein the virtual asset creation system is a virtual asset creation template.

3. The system for providing and dynamically deploying hardened task specific virtual hosts of claim 1 wherein the hardened task specific virtual host is a hardened task specific virtual host selected from the group of the hardened task specific virtual hosts consisting of:
a hardened virtual data cache;
a hardened virtual bastion host;
a hardened virtual administrative host;
a hardened virtual forensic analysis administrative host;
a hardened virtual gateway;
a hardened virtual machine;
a hardened virtual server;
a hardened database or data store;
a hardened instance in a cloud computing environment; and
a hardened cloud computing environment access control system.

4. The system for providing and dynamically deploying hardened task specific virtual hosts of claim 1 further comprising:
the deployed hardened task specific virtual host performing the specific function assigned to the hardened task specific virtual host; and
once the specific assigned function has been performed by the hardened task specific virtual host, retiring the hardened task specific virtual host.

5. The system for providing and dynamically deploying hardened task specific virtual hosts of claim 4 wherein retiring the hardened task specific virtual host includes recalling the hardened task specific virtual host from the first computing environment.

6. The system for providing and dynamically deploying hardened task specific virtual hosts of claim 4 wherein retiring the hardened task specific virtual host includes deleting the hardened task specific virtual host.

7. A system for providing and dynamically deploying hardened task specific virtual hosts comprising:
at least one processor; and
at least one memory coupled to the at least one processor, the at least one memory having stored therein instructions which when executed by any set of the one or more processors, perform a process for providing and dynamically deploying hardened task specific virtual hosts, the process for providing and dynamically deploying hardened task specific virtual hosts including:
generating two or more types of virtual host creation data through a virtual asset creation system, each of the two or more types of virtual host creation data for instantiating one of two or more types of hardened task specific virtual hosts in a first computing environment, the virtual host creation data for each type of hardened task specific virtual host including:
hardening logic for providing enhanced security and trust for the type of hardened task specific virtual host; and
internal task specific logic for directing and/or allowing each type of hardened task specific virtual host to perform a different specific function assigned to that type of hardened task specific virtual host;
receiving task data indicating a task to be performed in the first computing environment;
determining the task to be performed in the first computing environment requires the performance of two or more functions assigned to two or more types of hardened task specific virtual hosts; and
instantiating and deploying the two or more types of hardened task specific virtual hosts assigned the required different functions in the first computing environment using the virtual host creation data.

8. The system for providing and dynamically deploying hardened task specific virtual hosts of claim 7 wherein the virtual asset creation system includes two or more virtual asset creation templates.

9. The system for providing and dynamically deploying hardened task specific virtual hosts of claim 7 wherein at least one of the two or more hardened task specific virtual host types is selected from the group of hardened task specific virtual host types consisting of:
a hardened virtual data cache;
a hardened virtual bastion host;
a hardened virtual administrative host;
a hardened virtual forensic analysis administrative host;
a hardened virtual gateway;
a hardened virtual machine;
a hardened virtual server;
a hardened database or data store;
a hardened instance in a cloud computing environment; and
a hardened cloud computing environment access control system.

10. The system for providing and dynamically deploying hardened task specific virtual hosts of claim 7 further comprising:
the two or more types of hardened task specific virtual hosts performing the specific assigned functions associated with the two or more types of hardened task specific virtual hosts; and
once the specific assigned function associated with a given hardened task specific virtual host has been performed, retiring the hardened task specific virtual host.

11. The system for providing and dynamically deploying hardened task specific virtual hosts of claim 10 wherein retiring the hardened task specific virtual host includes recalling the hardened task specific virtual host from the first computing environment.

12. The system for providing and dynamically deploying hardened task specific virtual hosts of claim 10 wherein retiring the hardened task specific virtual host includes deleting the hardened task specific virtual host.

13. A system for providing and dynamically deploying hardened task specific virtual administrative hosts comprising:
at least one processor; and
at least one memory coupled to the at least one processor, the at least one memory having stored therein instructions which when executed by any set of the one or more processors, perform a process for providing and dynamically deploying hardened task specific virtual administrative hosts, the process for providing and dynamically deploying hardened task specific virtual administrative hosts including:
generating one or more types of virtual host creation data through a virtual asset creation system, each of the one or more types of virtual host creation data for instantiating one of one or more types of hardened task specific virtual administrative hosts in a first computing environment, the virtual host creation data for each type of hardened task specific virtual administrative host including:
hardening logic for providing enhanced security and trust for the type of hardened task specific virtual administrative host; and
internal task specific logic for directing and/or allowing each type of hardened task specific virtual administrative host to perform a different specific administrative function assigned to that type of hardened task specific virtual administrative host;
receiving task data indicating an administrative task to be performed in the first computing environment;
determining the administrative task to be performed in the first computing environment requires the performance of one or more administrative functions assigned to one or more of the one or more types of hardened task specific virtual administrative hosts; and
instantiating and deploying the one or more types of hardened task specific virtual administrative hosts assigned the required administrative functions in the first computing environment using the virtual host creation data.

14. The system for providing and dynamically deploying hardened task specific virtual administrative hosts of claim 13 wherein the virtual asset creation system includes one or more virtual asset creation templates.

15. The system for providing and dynamically deploying hardened task specific virtual administrative hosts of claim 13 wherein at least one of the one or more hardened task specific virtual administrative host types is selected from the group of hardened task specific virtual administrative host types consisting of:
a hardened virtual data cache;
a hardened virtual bastion host;
a hardened virtual forensic analysis administrative host;
a hardened virtual gateway;
a hardened virtual machine;
a hardened virtual server;
a hardened database or data store;
a hardened instance in a cloud computing environment; and
a hardened cloud computing environment access control system.

16. The system for providing and dynamically deploying hardened task specific virtual administrative hosts of claim 14 further comprising:
the one or more types of hardened task specific virtual administrative hosts performing the specific assigned administrative functions associated with the one or more types of hardened task specific virtual administrative hosts; and
once the specific assigned administrative function associated with a given hardened task specific virtual administrative host has been performed, retiring the hardened task specific virtual administrative host.

17. The system for providing and dynamically deploying hardened task specific virtual administrative hosts of claim 16 wherein retiring the hardened task specific virtual administrative host includes recalling the hardened task specific virtual administrative host from the first computing environment.

18. The system for providing and dynamically deploying hardened task specific virtual administrative hosts of claim 16 wherein retiring the hardened task specific virtual administrative host includes deleting the hardened task specific virtual administrative host.

19. A system for providing and dynamically deploying hardened task specific virtual bastion hosts comprising:
at least one processor; and
at least one memory coupled to the at least one processor, the at least one memory having stored therein instructions which when executed by any set of the one or more processors, perform a process for providing and dynamically deploying hardened task specific virtual bastion hosts, the process for providing and dynamically deploying hardened task specific virtual bastion hosts including:
generating one or more types of virtual host creation data through a virtual asset creation system, each of the one or more types of virtual host creation data for instantiating one of one or more types of hardened task specific virtual bastion hosts in a first computing environment, the virtual host creation data for each type of hardened task specific virtual bastion host including:
hardening logic for providing enhanced security and trust for the type of hardened task specific virtual bastion host; and
internal task specific logic for directing and/or allowing each type of hardened task specific virtual bastion host to perform a different specific function assigned to that type of hardened task specific virtual bastion host;
receiving task data indicating a task to be performed in the first computing environment;
determining the task to be performed in the first computing environment requires the performance of one or more functions assigned to one or more of the one or more types of hardened task specific virtual bastion hosts; and
instantiating and deploying the one or more types of hardened task specific virtual bastion hosts assigned the required different functions in the first computing environment using the virtual host creation data.

20. The system for providing and dynamically deploying hardened task specific virtual bastion hosts of claim 19 wherein the virtual asset creation system includes one or more virtual asset creation templates.

21. The system for providing and dynamically deploying hardened task specific virtual bastion hosts of claim 19 wherein at least one of the one or more hardened task specific virtual bastion host types is selected from the group of hardened task specific virtual bastion host types consisting of:
a hardened virtual data cache;
a hardened virtual gateway;
a hardened virtual machine;
a hardened virtual server;
a hardened database or data store;
a hardened instance in a cloud computing environment; and
a hardened cloud computing environment access control system.

22. The system for providing and dynamically deploying hardened task specific virtual bastion hosts of claim 19 further comprising:
the one or more types of hardened task specific virtual bastion hosts performing the specific assigned functions associated with the one or more types of hardened task specific virtual bastion hosts; and
once the specific assigned administrative function associated with a given hardened task specific virtual bastion host has been performed, retiring the hardened task specific virtual bastion host.

23. The system for providing and dynamically deploying hardened task specific virtual bastion hosts of claim 22 wherein retiring the hardened task specific virtual bastion host includes recalling the hardened task specific virtual bastion host from the first computing environment.

24. The system for providing and dynamically deploying hardened task specific virtual bastion hosts of claim 22 wherein retiring the hardened task specific virtual bastion host includes deleting the hardened task specific virtual bastion host.

25. A system for providing and dynamically deploying hardened task specific virtual bastion hosts comprising:
at least one processor; and
at least one memory coupled to the at least one processor, the at least one memory having stored therein instructions which when executed by any set of the one or more processors, perform a process for providing and dynamically deploying hardened task specific virtual bastion hosts, the process for providing and dynamically deploying hardened task specific virtual bastion hosts including:
receiving request data from a requesting virtual asset in a first computing environment, the request data requesting access to one more assets;
authenticating the requesting virtual asset;
generating one or more types of virtual host creation data through a virtual asset creation system, each of the one or more types of virtual host creation data for instantiating one of one or more types of hardened task specific virtual bastion hosts in the first computing environment, the virtual host creation data for each type of hardened task specific virtual bastion host including:
hardening logic for providing enhanced security and trust for the type of hardened task specific virtual bastion host; and
internal task specific logic for directing and/or allowing each type of hardened task specific virtual bastion host to perform a different specific function associated with the request data and assigned to that type of hardened task specific virtual bastion host;
instantiating and deploying the one or more types of hardened task specific virtual bastion hosts assigned the specific function associated with the request data in the first computing environment using the virtual host creation data; and
providing the requesting virtual asset access to the one or more types of hardened task specific virtual bastion hosts assigned the specific function associated with the request data.

26. The system for providing and dynamically deploying hardened task specific virtual bastion hosts of claim 25 wherein the virtual asset creation system includes one or more virtual asset creation templates.

27. The system for providing and dynamically deploying hardened task specific virtual bastion hosts of claim 25 wherein at least one of the one or more hardened task specific virtual bastion host types is selected from the group of hardened task specific virtual bastion host types consisting of:
a hardened virtual data cache;
a hardened virtual gateway;
a hardened virtual machine;
a hardened virtual server;
a hardened database or data store;
a hardened instance in a cloud computing environment; and
a hardened cloud computing environment access control system.

28. The system for providing and dynamically deploying hardened task specific virtual bastion hosts of claim 25 further comprising:
the one or more types of hardened task specific virtual bastion hosts performing the specific function associated with the request data assigned to the one or more types of hardened task specific virtual bastion hosts; and
once the specific function associated with the request data assigned a given hardened task specific virtual bastion host has been performed, retiring the hardened task specific virtual bastion host.

29. The system for providing and dynamically deploying hardened task specific virtual bastion hosts of claim 28 wherein retiring the hardened task specific virtual bastion host includes recalling the hardened task specific virtual bastion host from the first computing environment.

30. The system for providing and dynamically deploying hardened task specific virtual bastion hosts of claim 28 wherein retiring the hardened task specific virtual bastion host includes deleting the hardened task specific virtual bastion host.

31. A system for providing and dynamically deploying hardened task specific virtual hosts comprising:
at least one processor; and
at least one memory coupled to the at least one processor, the at least one memory having stored therein instructions which when executed by any set of the one or more processors, perform a process for providing and dynamically deploying hardened task specific virtual hosts, the process for providing and dynamically deploying hardened task specific virtual hosts including:
receiving task data indicating a task to be performed in a first computing environment;
determining the task to be performed in the first computing environment requires the performance of one or more task required functions;
generating one or more types of virtual host creation data through a virtual asset creation system, each of the one or more types of virtual host creation data for instantiating one of one or more types of hardened task specific virtual hosts in the first computing environment, the virtual host creation data for each type of hardened task specific virtual host including:
hardening logic for providing enhanced security and trust for the type of hardened task specific virtual host; and
internal task specific logic for directing and/or allowing each type of hardened task specific virtual host to perform a different specific function of the task required functions assigned to that type of hardened task specific virtual host; and
instantiating and deploying the one or more types of hardened task specific virtual hosts assigned the task required functions in the first computing environment using the virtual host creation data.

32. The system for providing and dynamically deploying hardened task specific virtual hosts of claim 31 wherein the virtual asset creation system includes one or more virtual asset creation templates.

33. The system for providing and dynamically deploying hardened task specific virtual hosts of claim 31 wherein at least one of the one or more hardened task specific virtual host types is selected from the group of hardened task specific virtual host types consisting of:
a hardened virtual data cache;
a hardened virtual bastion host;
a hardened virtual administrative host;
a hardened virtual forensic analysis administrative host;
a hardened virtual gateway;
a hardened virtual machine;
a hardened virtual server;
a hardened database or data store;
a hardened instance in a cloud computing environment; and
a hardened cloud computing environment access control system.

34. The system for providing and dynamically deploying hardened task specific virtual hosts of claim 31 further comprising:
the one or more types of hardened task specific virtual hosts performing the specific assigned task required functions assigned to the one or more types of hardened task specific virtual hosts; and
once the specific assigned task required function associated with a given hardened task specific virtual host has been performed, retiring the hardened task specific virtual host.

35. The system for providing and dynamically deploying hardened task specific virtual hosts of claim 34 wherein retiring the hardened task specific virtual host includes recalling the hardened task specific virtual host from the first computing environment.

36. The system for providing and dynamically deploying hardened task specific virtual hosts of claim 34 wherein retiring the hardened task specific virtual host includes deleting the hardened task specific virtual host.
